(19) United States
(12) Patent Application Publication
(10) Pub. No.: US 2004/0258274 A1
(43) Pub. Date: Dec. 23, 2004

(54) Camera, camera accessories for reading digital watermarks, digital watermarking method and systems, and embedding digital watermarks with metallic inks

(76) Inventors: Trent J. Brundage, Tigard, OR (US); Tony F. Rodriguez, Portland, OR (US); Steven Michael Shovoly, Portland, OR (US); Brian Labrec, North Oxford, MA (US)

Correspondence Address: DIGIMARC CORPORATION, 9405 SW GEMINI DRIVE, BEAVERTON, OR, 97008, US

(21) Appl. No.: 10/794,395

(22) Filed: Mar. 5, 2004

Related U.S. Application Data
(63) Continuation-in-part of application No. 10/359,550, filed on Feb. 5, 2003.
(63) Continuation-in-part of application No. 10/286,357, filed on Oct. 31, 2002.
(60) Provisional application No. 60/453,031, filed on Mar. 6, 2003.
(60) Provisional application No. 60/455,824, filed on Mar. 18, 2003.
(60) Provisional application No. 60/456,677, filed on Mar. 21, 2003.
(60) Provisional application No. 60/463,793, filed on Apr. 18, 2003.
(60) Provisional application No. 60/511,848, filed on Oct. 15, 2003.

(51) Int. Cl. G06K 9/00; G06K 9/18

(52) U.S. Cl. 382/100

(57) ABSTRACT

The present invention provides a camera and camera housing to improve reading digital watermarks. Another aspect of the invention is a method of authenticating identification documents. The identification document includes a first component. A separate overlay is placed over the identification document. The separate overlay includes a second component. The second component is used to resolve the first component. Still another method determines authenticity of a watermark based on a polarity associated with the watermark. The invention also provides an image capture and processing system and methods for portable devices that increase the image capture functionality of the devices, yet enable a compact mechanical design.

### RELATED APPLICATION DATA

This application is a continuation-in-part of U.S. patent application Ser. No. 10/359,550, filed Feb. 5, 2003 (published as US 2003-0174863 A1). The present application is also a continuation-in-part of U.S. patent application Ser. No. 10/286,357, filed Oct. 31, 2002. The present application also claims the benefit of U.S. Provisional Patent Application No. 60/453,031, filed Mar. 6, 2003, 60/455,824, filed Mar. 18, 2003, 60/456,677, filed Mar. 21, 2003, 60/463,793, filed Apr. 18, 2003, and 60/511,848, filed Oct. 15, 2003. The application is also related to U.S. patent application Ser. No. 10/165,751, filed Jun. 6, 2002 (published as US 2003-0026452 A1), which is a continuation of U.S. patent application Ser. No. 09/074,034, filed May 6, 1998 (now U.S. Pat. No. 6,449,377). Each of the above U.S. patent documents is herein incorporated by reference.

### FIELD OF THE INVENTION

The present invention relates generally to digital watermarking. The invention also relates to image processing, such as image capture and processing in portable devices like wireless telephones.

### BACKGROUND AND SUMMARY OF THE INVENTION

Counterfeiting and forgeries continue to proliferate. A hot area of counterfeiting is consumer products, such as cellular phones, logos, graphics and cameras. Often cellular phones include interchangeable faceplates. (Or a camera includes a logo plate, which is easily replicated by thieves.). A common counterfeiting scenario involves counterfeiting the faceplate, and then passing off the counterfeit faceplate as genuine.

One solution is to provide steganographic auxiliary data in or on consumer products to help prevent or detect counterfeiting. The data can be decoded to determine whether the object is authentic. The auxiliary data may also provide a link to a network resource, such as a web site or data repository. The absence of expected auxiliary data may provide a clue regarding counterfeiting.

One form of steganography includes digital watermarking. Digital watermarking systems typically have two primary components: an encoder that embeds the watermark in a host media signal, and a decoder (or reader) that detects and reads the embedded watermark from a signal suspected of containing a watermark. The encoder can embed a watermark by altering the host media signal. The decoding component analyzes a suspect signal to detect whether a watermark is present. In applications where the watermark encodes information, the decoder extracts this information from the detected watermark. Data can be communicated to a decoder, e.g., from an optical sensor.

One challenge to the developers of watermark embedding and reading systems is to ensure that the watermark is detectable even if the watermarked media content is transformed in some fashion. The watermark may be corrupted intentionally, so as to bypass its copy protection or anti-counterfeiting functions, or unintentionally through various transformations (e.g., scaling, rotation, translation, etc.) that result from routine manipulation of the content. In the case of watermarked images, such manipulation of the image may distort the watermark pattern embedded in the image.

A watermark can have multiple components, each having different attributes. To name a few, these attributes include function, signal intensity, transform domain of watermark definition (e.g., temporal, spatial, frequency, etc.), location or orientation in host signal, redundancy, level of security (e.g., encrypted or scrambled), etc. The components of the watermark may perform the same or different functions. For example, one component may carry a message, while another component may serve to identify the location or orientation of the watermark. Moreover, different messages may be encoded in different temporal or spatial portions of the host signal, such as different locations in an image or different time frames of audio or video. In some cases, the components are provided through separate watermarks.

There are a variety of alternative embodiments of an embedder and detector. One embodiment of an embedder performs error correction coding of a binary message, and then combines the binary message with a carrier signal to create a component of a watermark signal. It then combines the watermark signal with a host signal. To facilitate detection, it may also add a detection component to form a composite watermark signal having a message and detection component. The message component includes known or signature bits to facilitate detection, and thus, serves a dual function of identifying the mark and conveying a message. The detection component is designed to identify the orientation of the watermark in the combined signal, but may carry an information signal as well. For example, the signal values at selected locations in the detection component can be altered to encode a message.

One embodiment of a detector estimates an initial orientation of a watermark signal in a host signal, and refines the initial orientation to compute a refined orientation. As part of the process of refining the orientation, this detector may compute at least one orientation parameter that increases correlation between the watermark signal and the host signal when the watermark or host signal is adjusted with the refined orientation.

Another detector embodiment computes orientation parameter candidates of a watermark signal in different portions of a signal suspected of including a digital watermark, and compares the similarity of orientation parameter candidates from the different portions. Based on this comparison, it determines which candidates are more likely to correspond to a valid watermark signal.

Yet another detector embodiment estimates orientation of the watermark in a signal suspected of having a watermark. The detector then uses the orientation to extract a measure of the watermark in the suspected signal. It uses the measure of the watermark to assess merits of the estimated orientation. In one implementation, the measure of the watermark is the extent to which message bits read from the target signal match with expected bits. Another measure is the extent to which values of the target signal are consistent with the watermark signal. The measure of the watermark signal provides information about the merits of a given orientation that can be used to find a better estimate of the orientation. Of course other watermark embedder and detectors can be suitably interchanged with some embedding/detecting aspects of the present invention.

Example techniques for embedding and detecting watermarks in media signals are detailed in the assignee's co-pending U.S. Pat. Nos. 6,614,914 and 6,122,403 and PCT patent application PCT/US02/20832 (published as WO 03/005291), which are each herein incorporated by reference.

In the following disclosure it should be understood that references to watermarking and steganographic hiding encompass not only the assignee's technology, but can likewise be practiced with other technologies as well.

One aspect of the present invention provides a camera and/or camera housing for improved image capture of materials including steganographically embedded data.

Another aspect of the present invention relates to embedding digital watermarks in graphical icons or logos. The embedded objects can be used to effectuate responses in a wireless network.

Yet another aspect relates to digital watermarking with metallic inks. A watermark signal polarity is analyzed to determine whether a document is an original or counterfeit.

Still another aspect of the invention provides an image capture and processing system and methods for portable devices that increase image capture functionality of the devices, yet enable a compact mechanical design.

Another aspect of the invention is a portable device comprising an image capture system with two or more modes of image capture. One mode captures images at a short focal length, and another mode for captures images at a longer focal length. A sub-windowing module enables access to image streams captured at the short and longer focal lengths. This module enables a wide variety of imaging applications.

One inventive aspect of the present invention provides steganographic signals via laser engraving. A digital watermark is literally laser engraved into a document. A laser engraved watermark is a permanent way to steganographically mark identification documents. This type of steganography is also very difficult to replicate.

The foregoing and other features and advantages of the present invention will be even more readily apparent from the following detailed description, which proceeds with reference to the accompanying drawings. Of course, the drawings are not necessarily presented to scale, but rather focus on inventive aspects of the invention.

### BRIEF DESCRIPTION OF THE DRAWINGS

FIG. 1 illustrates changes to a width of a line to effect watermark encoding. FIG. 1 corresponds to FIG. 5 in related U.S. Pat. No. 6,449,377.

FIG. 2 illustrates a reflectance example for a specular surface.

FIG. 3 illustrates the specular surface of FIG. 2 including a steganographic signal conveyed through arrangement of ink or dye.

FIG. 4a illustrates a reflectance example for a preferred ink or dye that conveys a steganographic signal.

FIG. 4b illustrates a reflectance example including an optical sensor remotely located with respect to a light source.

FIG. 5a illustrates a flow diagram for a signal hiding method according to one aspect of the present invention.

FIG. 5b illustrates a flow diagram for the FIG. 5a method including a thresholding step.

FIG. 6 illustrates a cross-sectional view of a multi-layered disc according to one embodiment of the present invention.

FIG. 7 illustrates a light absorption example for an implementation using black ink to convey a steganographic signal.

FIGS. 8-12b illustrate various embodiments of a camera housing according one aspect of the present invention.

FIGS. 13a-13c illustrate a print and peel method and structure.

FIGS. 14a and 14b illustrate an over-lay for decoding or decryption of a separate object like a document.

FIG. 15a illustrates a printed document including steganographic indicia applied with metallic ink.

FIG. 15b illustrates image contrast in a first image captured of the FIG. 15a document.

FIG. 15c illustrates image contrast in a copy of the FIG. 15a document.

FIG. 16 is a diagram of a wireless telephone with a multi-mode image capture system for reading and processing images captured at different focal lengths.

FIG. 17a is a diagram of the telephone in FIG. 16 in an open position.

FIG. 17b is a diagram of an alternative configuration of the telephone in an open position.

FIG. 18 is a diagram of the telephone in FIG. 16 in closed position.

FIG. 19 is a diagram of an image capture system with two or more modes of operation.

FIG. 20 is a diagram showing a laser-engraving method according to one aspect of the present invention.

FIG. 21 illustrates a digital watermarking method using laser engraving.

FIG. 22A is a diagram illustrating an authenticating technique according to one aspect of the present invention.

FIG. 22B is a flow diagram illustrating an authenticating aspect of the FIG. 22A diagram.

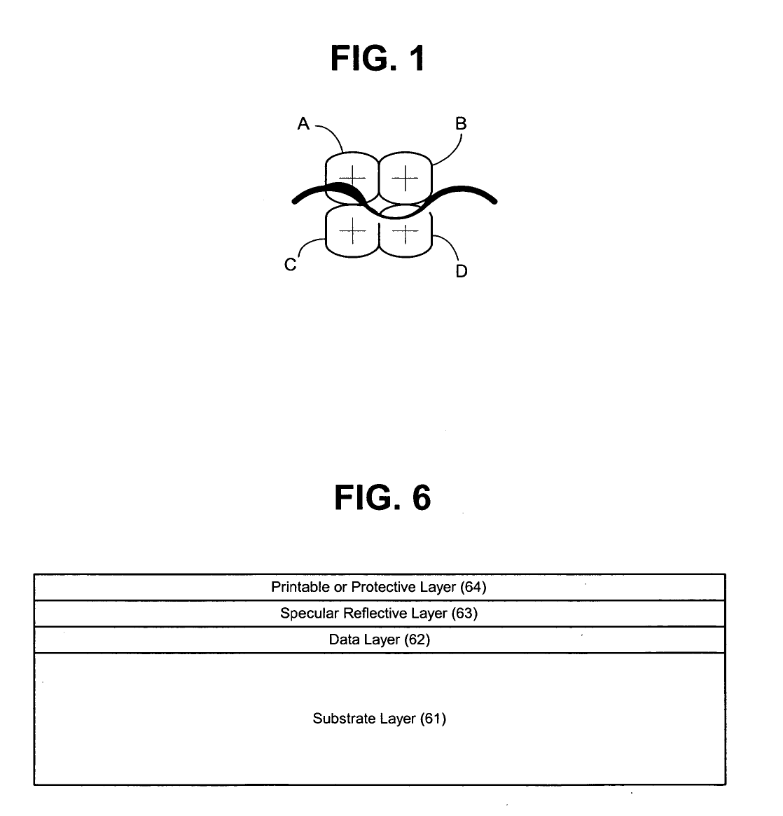

### DETAILED DESCRIPTION

In related U.S. Pat. No. 6,449,377 we teach:

In a first embodiment of the invention, shown in FIG. [1], the width of the line is controllably varied so as to change the luminosity of the regions through which it passes. To increase the luminosity (or reflectance), the line is made narrower (i.e. less ink in the region). To decrease the luminosity, the line is made wider (i.e. more ink).

Whether the luminance in a given region should be increased or decreased depends on the particular watermarking algorithm used. Any algorithm can be used, by changing the luminosity of regions 12 as the algorithm would otherwise change the luminance or colors of pixels in a pixelated image.

In an exemplary algorithm, the binary data is represented as a sequence of −1s and 1s, instead of 0s and 1s. (The binary data can comprise a single datum, but more typically comprises several. In an illustrative embodiment, the data comprises 100 bits.)

Each element of the binary data sequence is then multiplied by a corresponding element of a pseudo-random number sequence, comprised of −1s and 1s, to yield an intermediate data signal. Each element of this intermediate data signal is mapped to a corresponding sub-part of the image, such as a region 12. The image in (and optionally around) this region is analyzed to determine its relative capability to conceal embedded data, and a corresponding scale factor is produced. Exemplary scale factors may range from 0 to 3. The scale factor for the region is then multiplied by the element of the intermediate data signal mapped to the region in order to yield a “tweak” value for the region. In the illustrated case, the resulting tweaks can range from −3 to 3. The luminosity of the region is then adjusted in accordance with the tweak value. A tweak value of −3 may correspond to a −5% change in luminosity; −2 may correspond to −2% change; −1 may correspond to −1% change; 0 may correspond to no change; 1 may correspond to +1% change; 2 may correspond to +2% change, and 3 may correspond to +5% change. (This example follows the basic techniques described in the Real Time Encoder embodiment disclosed in U.S. Pat. No. 5,710,834.)

In FIG. [1], the watermarking algorithm determined that the luminance of region A should be reduced by a certain percentage, while the luminance of regions C and D should be increased by certain percentages.

In region A, the luminance is reduced by increasing the line width. In region D, the luminance is increased by reducing the line width; similarly in region C (but to a lesser extent).

No line passes through region B, so there is no opportunity to change the region's luminance. This is not fatal to the method, however, since the watermarking algorithm redundantly encodes each bit of data in sub-parts spaced throughout the line art image.

The changes to line widths in regions A and D of FIG. [1] are exaggerated for purposes of illustration. While the illustrated variance is possible, most implementations will modulate the line width 3-50% (increase or decrease).

In still a further embodiment, the luminance in each region is changed while leaving the line unchanged. This can be effected by sprinkling tiny dots of ink in the otherwise-vacant parts of the region. In high quality printing, of the type used with banknotes, droplets on the order of 3 μm in diameter can be deposited. (Still larger droplets are still beyond the perception threshold for most viewers.) Speckling a region with such droplets (either in a regular array, or random, or according to a desired profile such as Gaussian), can readily effect a 1% or so change in luminosity. (Usually dark droplets are added to a region, effecting a decrease in luminosity. Increases in luminosity can be effected by speckling with a light colored ink, or by forming light voids in line art otherwise present in a region.)

In a variant of the speckling technique, very thin mesh lines can be inserted in the artwork—again to slightly change the luminance of one or more regions.

Watermarking Specular Surfaces

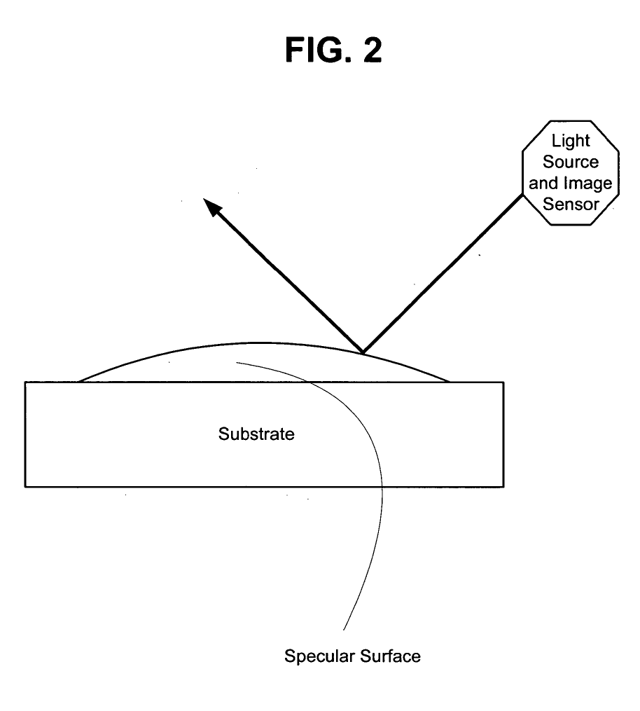

We have found that we can apply analogous and/or improved techniques to steganographically encode specular reflective surfaces. With reference to FIG. 2, a specular surface generally reflects light away from (and not generally back to) the light's source. In one implementation, a specular surface reflects light in a directional manner such that the angle of reflection is equal to the angle of incidence. While the specular surface of FIG. 2 is illustrated as being adjacently arranged with a substrate, the present invention is not so limited.

Specular surfaces can be devoid of text or images, and often include a metallic-like surface luster (or finish). Examples of specular reflective materials include some of 3M's Radiant Light Films™ (e.g., 3M's Radiant Mirror and Visible Mirror products). The Radiant Light Films™ can be combined with a Lexan® sheet (from GE Corporation) and an over-laminate (e.g., a polycarbonate, polyvinyl fluoride, polyester, etc.). Dorrie Corporation in the United States provides a variety of suitable laminates. Of course, a specular surface can include coloration and textures (e.g., tints, patterns, sparkles, etc.). Some of these specular surfaces even change color hue at different viewing angles and thinning ratios across the specular surface (e.g., 3M's Color Mirror Film). Of course specular surface may be arranged to convey or include text or graphics.

Steganographically encoding specular surfaces has heretofore presented unique challenges. A first challenge is that with such a reflective surface, information is difficult to hide without being aesthetically displeasing. A second challenge is signal detection. Some steganographic readers include or cooperate with a light source (e.g., LED or illumination source) to facilitate better detection. These steganographic readers often position or co-locate an optical image sensor at or near the light source. Yet, with a specular surface, light reflects away from the light source (and optical image sensor), yielding little or no optical data for capture by the optical sensor. An optical sensor would need to be placed along the angle of reflection to capture relevant optical data. This configuration is awkward and heretofore has been difficult to obtain consistent reads with a steganographic reader. Accordingly, it is very difficult to capture and read a signal on a specular surface.

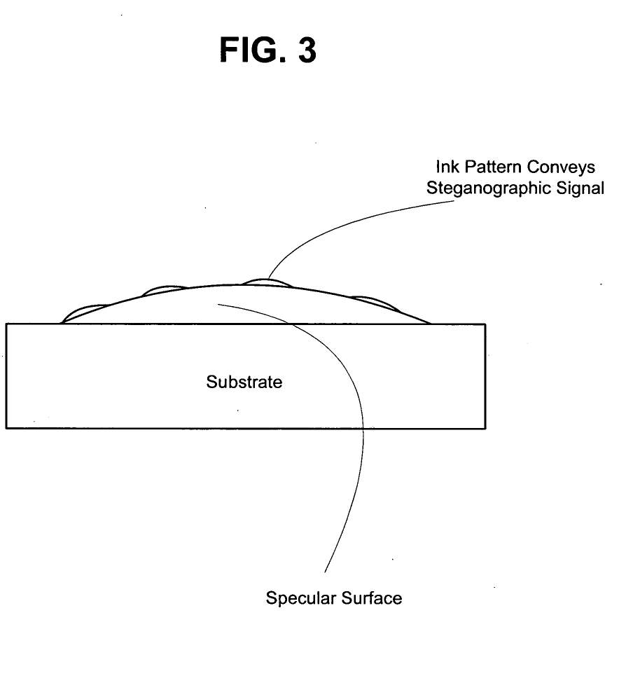

With reference to FIG. 3, we overcome these challenges by sprinkling (or providing, over-printing, etc.) ink and/or dye on the specular surface. The ink or dye is provided on the specular surface so as to convey a steganographic signal.

The ink or dye is preferably selected or applied to blend in, hide or otherwise avoid contrast with the specular surface. For example, if the specular surface includes a chrome, gold or silver coloration, the ink or dye preferably includes at least a complimentary chrome, gold or silver coloration. Or if the specular surface includes a pattern or background, the ink or dye can be selected to match or otherwise blend in with the pattern or background. In other cases the ink or dye is generally opaque or transparent. Yet the transparent ink still preferably includes favorable reflective properties. Still further, the ink can be selected to include a somewhat glossy finish so as to even further improve the ink's hiding characteristics. In other implementations the ink includes a dull or even matt-like finish. A dull or matt-like finish may provide preferred reflection properties (e.g., approximating Lambertian reflection) as discussed below.

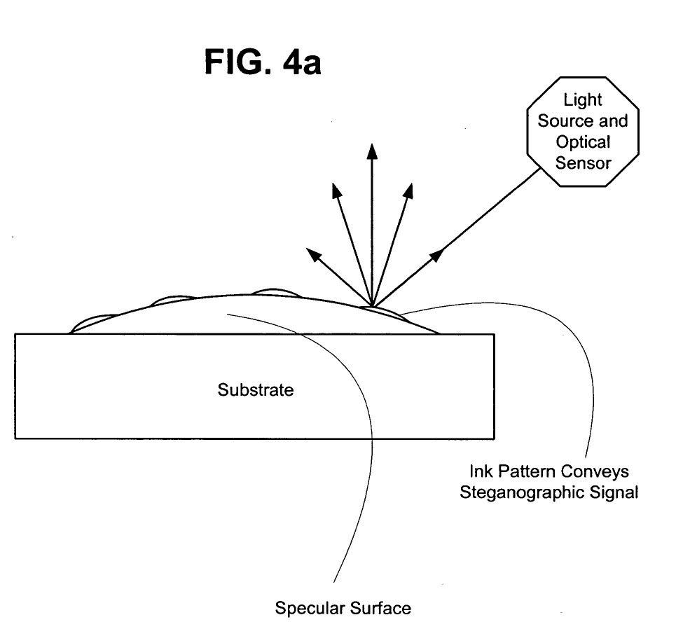

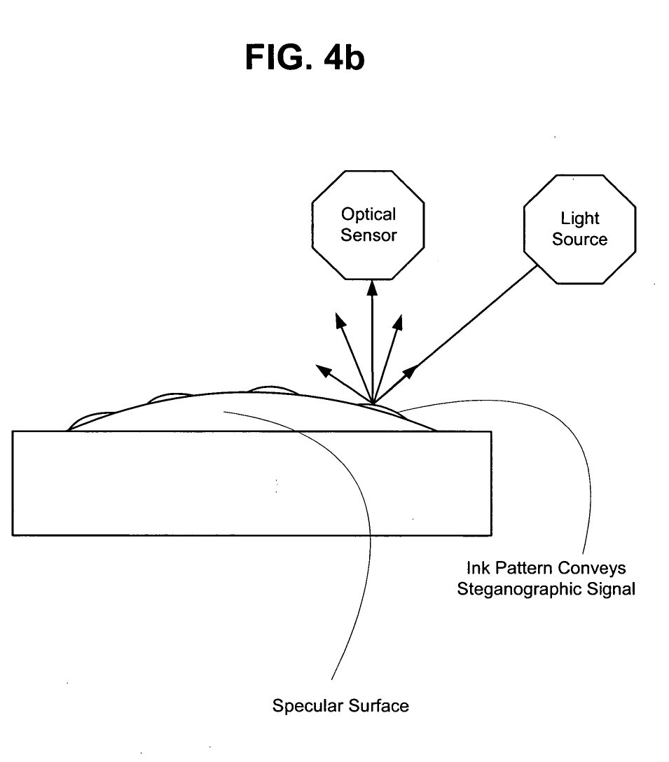

The ink or dye preferably comprises a diffuse reflection surface or property. A diffuse reflection surface is one that generally diffuses a light ray in multiple directions, including, e.g., back toward the source of the light ray (see FIG. 4a). This characteristic allows for steganographic signal capture by an optical sensor positioned at or near a light source. For example, the optical sensor captures optical scan data that includes a representation of the steganographic signal. The captured scan data is communicated to a decoder to decipher the steganographic signal. (In some implementations the ink approximates Lambertian reflection, which implies that the ink reflects light in multiple directions, and hence can be perceived (or optically captured) from the multiple directions. With Lambertian reflection, the brightness of a reflected ray depends on an angle between a direction of the light source and the surface normal.). We note, with reference to FIG. 4b, that the optical sensor need not be positioned at the light source, but instead can be positioned to receive another (or additional) reflected light ray(s). One FIG. 4b implementation packages the optical sensor and light source in a signal apparatus (e.g., a hand-held steganographic signal detector).

The steganographic signal preferably conveys a message or payload. In some implementations the message or payload includes a unique identifier for identifying the object or surface. Or the message or payload may provide authentication clues. In other implementations the message or payload provides auxiliary information, e.g., pertaining to an associated object or manufacturing details, distribution history, etc. In still other implementations the message or payload includes a link or index to a data repository. The data repository includes the identifier, authentication clues, and/or auxiliary information. (See assignee's U.S. patent application Ser. No. 09/571,422, herein incorporated by reference, for some related linking techniques. The disclosed techniques are suitably interchangeable with the linking aspect of the present invention.).

The steganographic signal may be optionally fragile, e.g., the signal is destroyed (or becomes irreproducible) or predictably degrades upon signal processing such as scanning and printing.

The steganographic signal may include an orientation component which is useful in helping to resolve image distortion such as rotation, scaling, and translation, etc., and/or to help detect the message or payload. The orientation component may be a separate signal, or may be combined (or concatenated) with the message or payload.

The steganographic signal may also be redundantly provided across a specular surface so as to redundantly convey the orientation, message or payload (or plural-bit data). Or the signal may be object or location specific. For example, if the specular surface includes a graphic or background pattern/texture/tint, the signal can be limited to the graphic or background pattern/texture/tint.

In one implementation, the ink pattern is arranged according to a so-called digital watermark signal. The signal can be a “pure” or “raw” signal. A pure or raw digital watermark signal is generally one that conveys information without influence or consideration of a host image or text. In some implementations the pattern appears as (or includes) a background texture or tint. In other implementations the pattern appears as if a random (or pseudo-random) pattern.

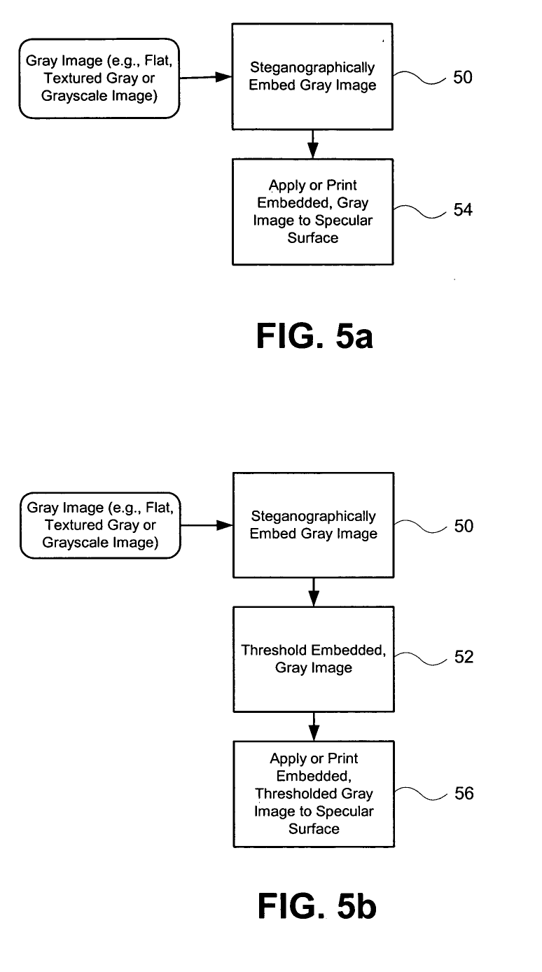

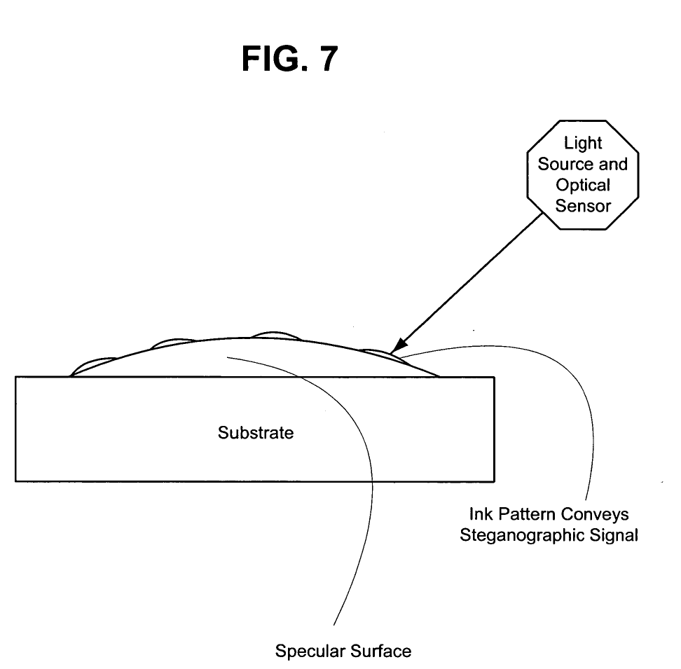

In one digital watermarking implementation, and with reference to FIG. 5a, we start with a gray or monotone image (e.g., a flat gray image including substantially uniform pixel values or subtly varying grayscale texture, tint or pattern). We can use standard image editing software such as Adobe's Photoshop or Jasc Software's PaintShop Pro, etc., etc. to provide the gray image. The gray image serves as a “host” image and is passed to a digital watermark-embedding module (step 50). The digital watermarking module can encode the gray image, e.g., based on a transform domain watermark embedding technique or spatial domain watermark embedding technique, etc. The resulting embedded, gray image is then printed or otherwise applied to the specular surface (step 54). (In some implementations, a specular surface is provided as a thin film, which can be readily feed through an offset printing press or laser/ink jet printer.).

In another implementation, we “threshold” the embedded gray image prior to printing or applying to the specular surface (step 52 in FIG. 5b). Generally, thresholding reduces the watermark signal and/or-watermarked image. In one implementation, a watermark signal is embedded as a plurality of peaks and valleys (or plus and minus signal tweaks). The tweaks can be encoded in a gray image by changing or effecting pixel values, e.g., changing gray-scale levels for pixels. (We note that transform domain embedding also effects pixels values.). Thresholding this embedded gray image may then include selecting a grayscale level (e.g., level 128 in an 8-bit (or 256 level) grayscale image) and discarding some or all pixels with a grayscale level below (or above) level 128. Of course, there are many other thresholding techniques that can be employed, such as filtering the embedded gray image, creating a binary image (e.g., toggling image pixels to be on or off based on pixel values of the embedded gray image), discarding pixels based on coefficient values (or blocks of coefficient values), etc., etc. The thresholded, embedded gray image is then applied or printed to the specular surface (56).

In some implementations two or more digital watermarks are provided in the steganographic signal. The two or more watermarks can cooperate for authentication. For example, each of the two watermarks may include overlapping payload information that can be compared to determine authenticity. Or a first digital watermark may be fragile, while a second digital watermark is robust. Still further, a first digital watermark may include an orientation component, while the second digital watermark includes a message or payload. Or a first digital watermark may include a key to decrypt or otherwise assist in decoding a second digital watermark.

If using a sheet of specular material (e.g., 3M's Radiant Light Films), ink can be printed (e.g., screen-printed, dye-diffusion thermal transfer (D2T2), and ink or laser jet printing, etc.) directly onto the sheet. A tie coat can be laid down on the film, prior to printing, to help the ink better adhere to the film's surface.

The printed sheet can then be applied to an object such as a consumer device, electronics device, label, sticker, identification documents (e.g., driver's licenses, passports, identification cards, badges, access cards, etc.) certificate, automobile (e.g., as a paint substitute or as an overlay, etc.), credit cards, personal digital assistants (PDAs), molded logos (e.g., for attachment to articles such as shoes and clothing, equipment or consumer products), handheld and console video games, pagers, dashboards, stereo faceplates or covers, plastic articles, etc. The printed sheet can also be used as or in conjunction with a holographic structure or optical variable device. In some cases we even use the specular surface as a hologram-like structure or component.

In one embodiment, the printed sheet is provided to a molding process, e.g., as contemplated in our related U.S. patent application Ser. No. 10/286,357. (We note that the injection molding techniques disclosed herein and in application Ser. No. 10/286,357 can be suitably interchanged with other conventional injection molding techniques as well.). In some implementations of this embodiment, the printed sheet is combined with (e.g., adhered to) a carrier sheet such as a Lexan® polycarbonate sheet (Lexan® is provided by GE Plastics in the United States). A layered printed specular sheet/Lexan® sheet structure is also hereafter referred to as a “printed sheet.” The printed sheet is provided to an injection mold, perhaps after pre-forming or pre-molded the printed sheet. The printed sheet is preferably positioned in the mold so as to have the bottom surface of the printed sheet adjacent to a second material, e.g., injected polycarbonate or polymeric resin (or other suitable injection materials). A three-dimensional object results including a printed specular sheet/Lexan®/injection material structure. (We note that the various layer materials will sometimes fuse or migrate into other layers during an injection molding process.) We can also provide an over-laminate (e.g., polycarbonate, polyester, polyurethane, etc.) over the printed specular surface. The printed steganographic signal can be reversed if applied to a bottom layer of the printed sheet when the signal will be viewed from a top-surface of the printed sheet. Reversing the printing will typically allow for an easier read when the signal is scanned from a top layer of the printed sheet.

In another molding implementation, we provide the printed specular sheet to be sandwiched in between a sheet of Lexan® and injection molding material. The Lexan® is preferably somewhat transparent to allow viewing of the printed specular surface through the Lexan®.

In a related embodiment, we provide a substrate (e.g., a Lexan® sheet) and a specular surface (e.g., a Radiant Light Film®) adjacently arranged on or adhered to the substrate (collectively referred to as a “structure”). The specular surface is printed to include a steganographic signal as discussed herein. The structure can optionally include a laminate layer. The structure is then used as a laminate or covering. The laminate or covering is applied (e.g., with an adhesive or via a molding process) to various objects (cell phones, automotive parts, labels, identification documents, plastic parts, computer equipment, etc.).

Another embodiment involves the application of our techniques to compact discs (e.g., CDs, CD-Rs and CD-RWs) and digital video discs (e.g., DVDs, DVD-Rs and DVD-RWs). An example is given with respect to CD-Rs, but our techniques apply to other CDs and DVDs as well. With reference to FIG. 6, a CD-R generally includes a multi-layered structure including a plastic (e.g., polycarbonate) substrate (61), a translucent data layer of recordable material such as an organic dye (62) and a specular reflective layer (63). Some CD-Rs also have an additional protective or printable coating (64) adjacent to the specular reflective layer (63).

When making CD-R media, instead of pits and lands, a spiral is pressed or formed into the substrate, e.g., by injection molding from a stamper, as a guide to a recording laser. The recording laser selectively melts the translucent data layer of CD-R discs during the recording process. The positions where the data layer is melted becomes opaque or refractive, scattering a reading laser beam so it is not reflected back (or is reflected as a different intensity) into a reader's sensors. The reader interprets a difference between reflected and non-reflected light as a binary signal.

We can apply our steganographic signal on a top or bottom side of the specular reflective layer 63 (or other adjacently arranged layers) as discussed above. We preferably threshold the steganographic signal (or embedded grayscale image) prior to application to the specular reflective layer 63. A high threshold will help prevent disc reading errors due to the printed ink.

In one implementation of this embodiment, the steganographic signal includes a decoding key. The decoding key is used to decode (or decrypt) the data (e.g., audio, video, data) on the disc. In another implementation, the steganographic signal includes an identifier which is used to determine whether the disc is authentic. Illegal copies will not include the steganographic watermark on the specular surface—evidencing an unauthorized copy.

Camera Housing and Reflective Sleeve

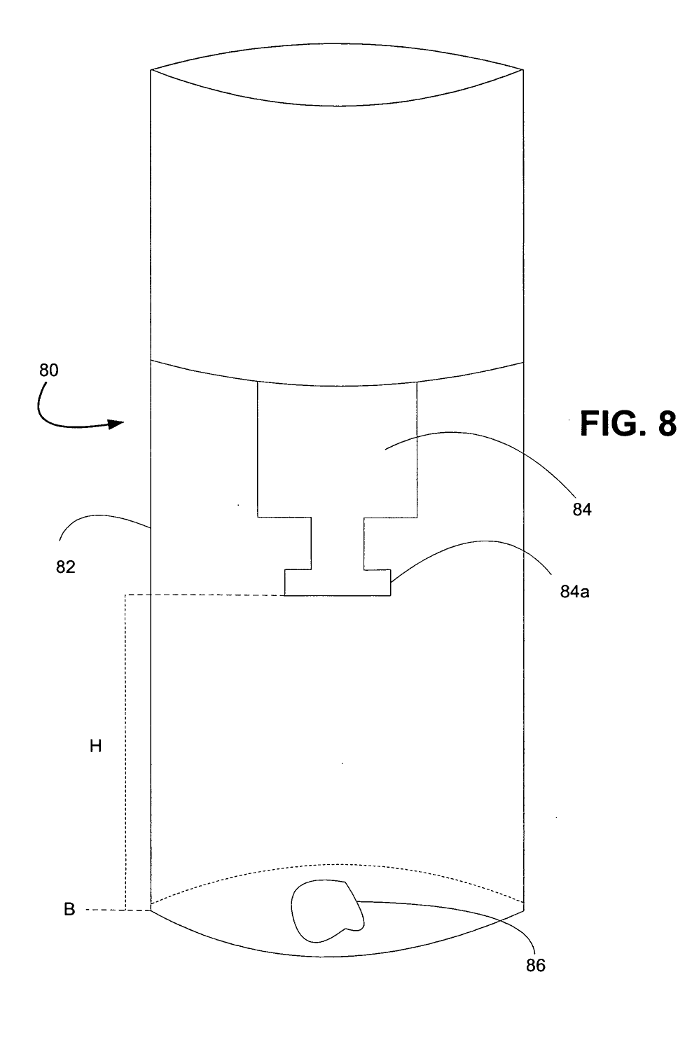

FIG. 8 illustrates an inventive camera accessory or housing 80 according to one aspect of the present invention. The housing 80 is particularly beneficial for optimally capturing images of digitally watermarked materials. Camera housing 80 preferably includes a cylindrical shaped tube 82. In other embodiments, the housing 80 includes a cone shape, rectangle shape, or oval shape, etc. A camera 84 is positioned within the housing 80 so that a height H of a camera lens assembly 84a from an image subject or object is optimally achieved for a particular digital watermarking application. The housing 80 may include a stop to establish a position for the lens 84a, or the lens 84a may be otherwise placed within the housing 80 to achieve the height H. The height H is chosen to achieve an optimal image focus. The housing 80 fixes the distance from lens assembly 84a to the material 86 to be optically captured (the so-called “subject distance”), thus, alleviating a need to manually move the lens assembly 84a closer to or farther away from material 86 to capture focused imagery. (Even cameras with an “auto focus” feature will benefit from our housing 80 by eliminating auto focus search time.). The height H is preferably determined, at least in part, by the properties of the camera's 84 optics and the resolution of the material 86 to be captured and/or the resolution of the embedded data with the material 86. (We note here that our preferred height H allows for some over-sampling of embedded digitally watermarked material.).

The housing 80 is placed over a watermarked object or substrate 86 and the camera 84 captures an image of the object or substrate 86. (One suitable camera is the MiniVID Microscope Camera available, e.g., from Micro Enterprises Inc., in Norcross, Ga. The MiniVID captures both video and still imagery. Another suitable camera is the LF-MO3 or LF-MO4 USB CMOS Camera (or other LF models) made by LinkCam Technologies, Inc. of Taipei Hsien, Taiwan, R.O.C. Of course, there are many other cameras that can be suitably interchanged with this aspect of the present invention.). The housing's lower portion B is preferably open, but may also be enclosed if the enclosure is transparent to allow image capture through the enclosure.

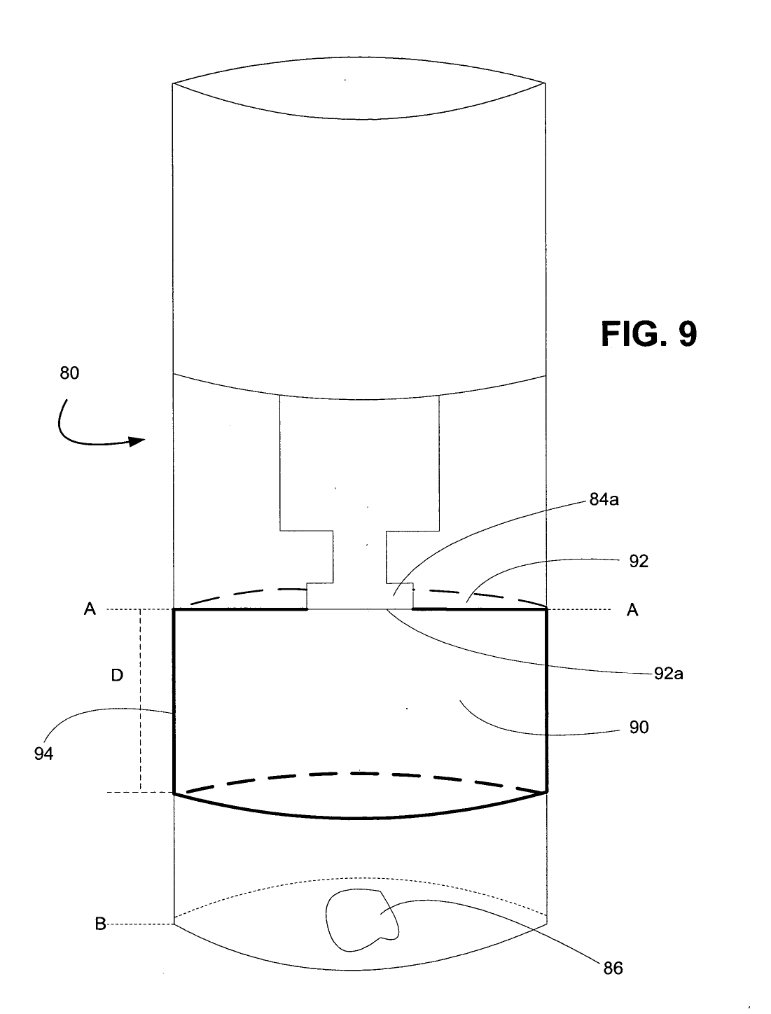

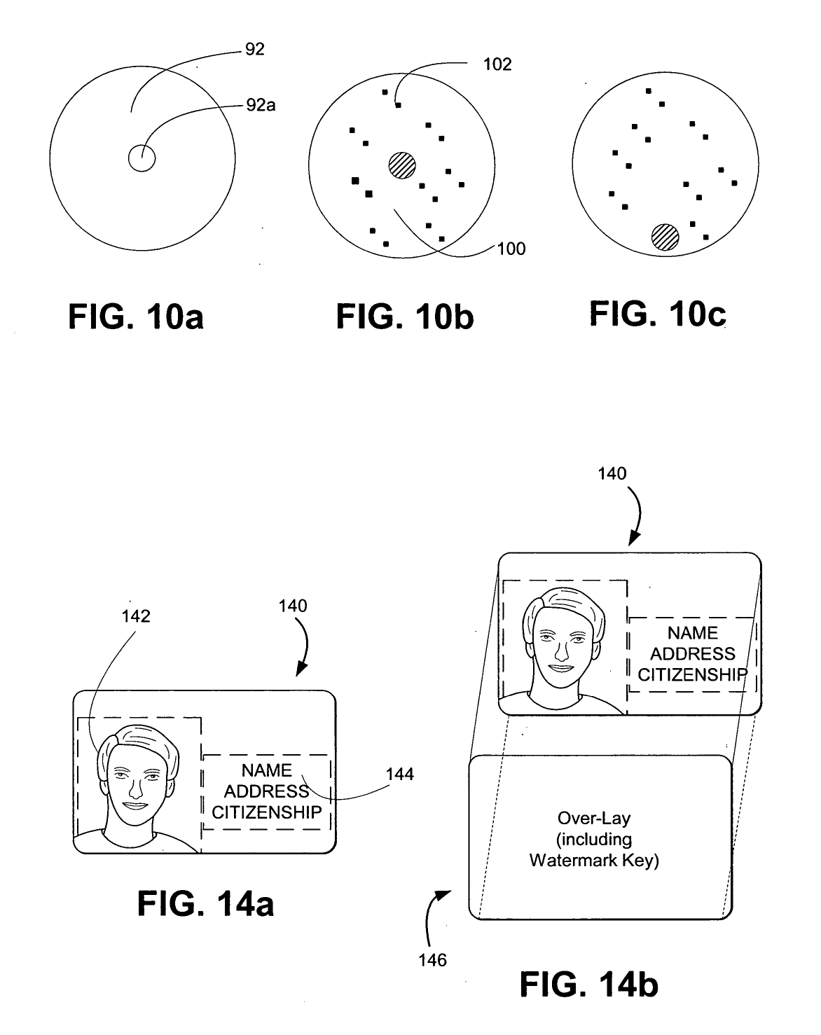

With reference to FIG. 9 we provide a reflective sleeve or favorably colored surface 90 within the housing assembly 80. The sleeve 90 includes an upper surface 92, which preferably resides near or on the same plane as a bottom portion of lens assembly 84a. The upper surface 92 includes an opening 92a to allow image capture by the lens assembly 84a through the opening 92a. (The upper surface 92 is illustrated in FIG. 10a from a perspective of looking up into the housing 80, e.g., looking into the lower portion B towards the A-A line in FIG. 9—resulting in a doughnut shaped disc when the shape of the housing 80 is a cylinder.). The sleeve 90 optionally includes a hollow, cylindrical portion 94 that extends a distance D from the upper surface 92 toward the lower portion B. The distance D can be selected to provide optimal reflectivity from the portion 94, perhaps with consideration of the camera's field of view. In some implementations the sleeve 90 is removable from the housing 80 (e.g., a separate vinyl or polymer based component). In other implementations the sleeve 90 is integrated within the housing 80 itself. In still other cases, the sleeve 90 includes a differently colored (or painted) portion of the housing 80.

The sleeve 90 provides favorably-colored surfaces (e.g., 92 and, optionally, 94). Light is reflected from the favorably-colored surface to the material 86, which reflects the light (and, hence the favorable color) back to the lens assembly 84a. The reflection is quite pronounced, e.g., when the material 86 includes a high gloss, metallic finish or specular surface.

The sleeve 90 (e.g., surface 92 and/or surface 94) preferably includes a coloration that is selected according to a material 86 to be imaged. For example, if imaging a specular surface including a steganographic message conveyed thereon through black or dark ink (e.g., a surface as shown in FIG. 3), the sleeve color is preferably white or at least a relatively light color. From the lens assembly's 84a perspective, captured imagery includes a reflection of the white (or relatively light) surface 92/94 from the specular surface. A captured image will include dark voids arranged therein that correspond to the black ink positions on the specular surface. The reflected white coloration provides background contrast for the steganographic signal (e.g., conveyed with the dark voids). Of course, the sleeve color is not limited to white, as its coloration can be widely varied so long as the sleeve surface coloration contrasts with the steganographic signal color. For example, if the steganographic signal is conveyed with yellow ink, the sleeve coloration can be green or red.

A decoder uses the relative changes in contrast to recover the steganographic signal. For example, the values of pixel data produced by a scanner may reflect the foregoing alterations in contrast (e.g., in terms of luminance values, grayscale values, color values or frequency domain representations of such), permitting the steganographic signal to be decoded.

FIG. 10b illustrates an example image as would be typically captured by the camera 84 when placed in the housing of FIG. 9. The image includes a reflected white background 100 (reflected from the sleeve surface 92) along with relatively dark voids or portions 102 that are attributable to black (or other color) ink. Due to the positioning of the lens in housing 80, however, the image may include a reflection of the lens in the specular surface (shown as a dashed inner circle in FIG. 10b). The reflection of the lens may not always include enough contrast to distinguish over the dark voids. However, this generally will not pose a problem when the steganographic signal is, e.g., redundantly encoded through the material 86 or sufficiently error correction encoded.

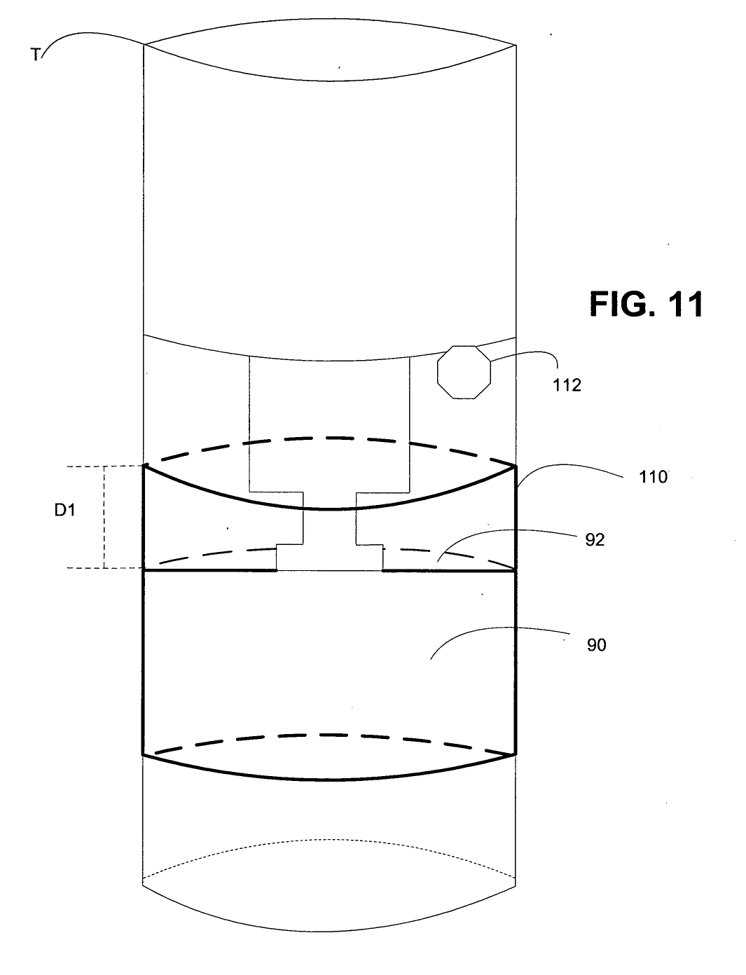

FIG. 11 illustrates an embodiment where the sleeve 90 includes a portion 110 that extends from the upper surface 92 toward the top of the housing T. Extension distance D1 can be chosen to help improve the reflective characteristics of the sleeve 90 and to block out unwanted illumination. Also, an illumination source(s) 112 can be optionally provided above (or below) the sleeve 90 to help achieve consistent and/or favorable lighting conditions. (Suitable illumination sources, e.g., white light or red/yellow/green LEDs, can be provided from a number of vendors including Lumex, Inc. (with headquarters in Palatine, Ill. USA) and Stanley Electric Sales of America, Inc. (with an office in Irvine, Calif. USA). Of course there are a variety of other suitable illumination sources and vendors that can be interchanged with this aspect of the present invention.). If positioned below the sleeve (not shown), the illumination source can be positioned to provide light primarily directed toward the sleeve or sleeve surface 92.

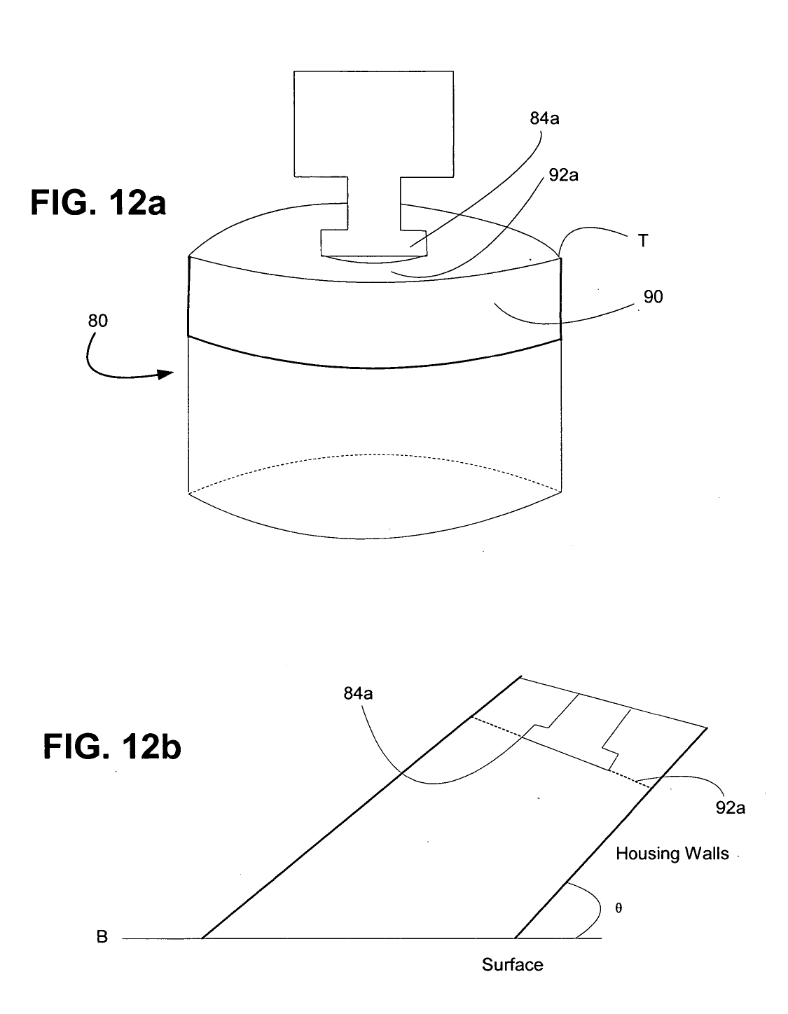

A camera and lens assembly need not fit within the housing as shown in FIGS. 8, 9 and 11. Instead, and with reference to FIG. 12a, a lens assembly 84a can be positioned at the top surface T of the housing 80 and in cooperation with opening 92a. A sleeve 90 can be accordingly positioned within the housing to provide desired contrast reflection.

A camera and housing can be optionally domed or shaped to better fit within the palm of a user's hand.

An alternative configuration is shown in FIG. 12b. A camera housing lower portion B is provided to from an angle θ between a surface to be imaged and the housing walls. (The housing 80 shown in FIG. 12a can be similarly angled.) This configuration helps offset reflection from the lens assembly 84a in captured imagery. For example, and with reference to FIG. 10c, the reflection from lens assembly 84a (shown as a dashed circle) is offset from a center image location. Depending of the camera's field of view and the angle θ, the reflection due to the lens assembly 84a may be removed completely. The positioning of the lens within the housing as shown in FIG. 12b may introduce some image distortion for captured imagery. Such distortion is readily corrected with image transformations. For example, since we know the camera capture angle with respect to the material, we can re-sample the image to help remove the distortion. Moreover, if a steganographic signal includes an orientation component, the orientation component can be used to help resize or realign an image prior to message detection.

There are a number of other possible combinations for our camera housing and sleeves, e.g., when combined with cameras disclosed in application Ser. Nos. 09/343,101 and 09/482,786, and U.S. Pat. Nos. 6,311,214 and 6,513,717, which are each herein incorporated by reference.

Laser Engraving

Identification Documents

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening, and/or prior to boarding their flight. In addition, because we live in an ever-evolving cashless society, ID documents are used to make payments, access an ATM, debit an account, or make a payment, etc.

Many types of identification cards and documents, such as driving licenses, national or government identification cards, passports, visas, smartcards, bank cards, credit cards, controlled access cards and smart cards, carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

In the production of images useful in the field of identification documentation, it is oftentimes desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

Commercial systems for issuing ID documents are of two main types, namely so-called “central” issue (CI), and so-called “on-the-spot” or “over-the-counter” (OTC) issue.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail. Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a drivers license card through the mail.

Centrally issued identification documents can be produced from digitally stored information and generally comprise an opaque core material (also referred to as “substrate”), such as paper or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents. Another security advantage with centrally issued documents is that the security features and/or secured materials used to make those features are centrally located, reducing the chances of loss or theft (as compared to having secured materials dispersed over a wide number of “on the spot” locations).

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents are manufactured.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document.

OTC identification documents of the types mentioned above can take a number of forms, depending on cost and desired features. Some OTC ID documents comprise highly plasticized polyvinyl chloride (PVC) or have a composite structure with polyester laminated to 0.5-2.0 mil (13-51 .mu.m) PVC film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 .mu.m) overlay patches applied at the print head, holographic hot stamp foils (0.125-0.250 mil 3-6 .mu.m), or a clear polyester laminate (0.5-10 mil, 13-254 .mu.m) supporting common security features. These last two types of protective foil or laminate sometimes are applied at a laminating station separate from the print head. The choice of laminate dictates the degree of durability and security imparted to the system in protecting the image and other data.

Laser beams can be used for marking, writing, and engraving many different types of materials, including plastics. Lasers have been used, for example, to mark plastic materials to create indicia such as date codes, part numbers, batch codes, and company logos. It will be appreciated that laser engraving or marking generally involves a process of inscribing or engraving a document surface with identification marks, characters, text, tactile marks—including text, patterns, designs (such as decorative or security features), photographs, etc.

One way to laser mark thermoplastic materials involves irradiating a material, such as a thermoplastic, with a laser beam at a given radiation. The area irradiated by the laser absorbs the laser energy and produces heat, which causes a visible discoloration in the thermoplastic. The visible discoloration serves as a “mark” or indicator; it will be appreciated that laser beams can be controlled to form patterns of “marks” that can form images, lines, numbers, letters, patterns, and the like. Depending on the type of laser and the type of material used, various types of marks (e.g., dark marks on light backgrounds, light marks on dark backgrounds, colored marks) can be produced. Some types of thermoplastics, such as polyvinylchloride (PVC), acrylonitrile butadiene styrene (ABS), and polyethylene terephthalate (PET), are capable of absorbing laser energy in their native states. Some materials, which are transparent to laser energy in their native state, such as polyethylene, may require the addition of one or more additives to be responsive to laser energy.

For additional background, various laser marking and/or engraving techniques are disclosed, e.g., in U.S. Pat. Nos. 6,022,905, 5,298,922, 5,294,774, 5,215,864 and 4,732,410. Each of these patents is herein incorporated by reference. In addition, U.S. Pat. Nos. 4,816,372, 4,894,110, 5,005,872, 5,977,514, and 6,179,338 describe various implementations for using a laser to print information, and these patents are incorporated herein in their entirety.

Laser engraving facilitated by the inventive techniques disclosed herein can be used to provide a digital watermark to any indicia printed (whether conventionally or by laser engraving) on any layer of the ID document 10. (While we have described some of our preferred laser engraving techniques herein, it should be appreciated that other laser engraving techniques can be suitable interchanged with some watermarking applications.)

The ability to provide gray scale images on an identification document using a laser, in accordance with the invention, can be advantageous because it can provide increased security of the identification document. In addition, it may be possible to use the invention incorporate additional security features (such as digital watermarks) into the laser engraved grayscale image. As discussed below, digital watermarks can also be conveyed via color laser engraving as well.

In an illustrative embodiment, an ID document includes a digital watermark steganographically encoded therein via laser engraving. As discussed herein, digital watermarking is a process for modifying physical or electronic media to embed a machine-readable code into the media. The media may be modified such that the embedded code is imperceptible or nearly imperceptible to the user, yet may be detected through an automated detection process. In some embodiments, the identification document includes two or more digital watermarks.

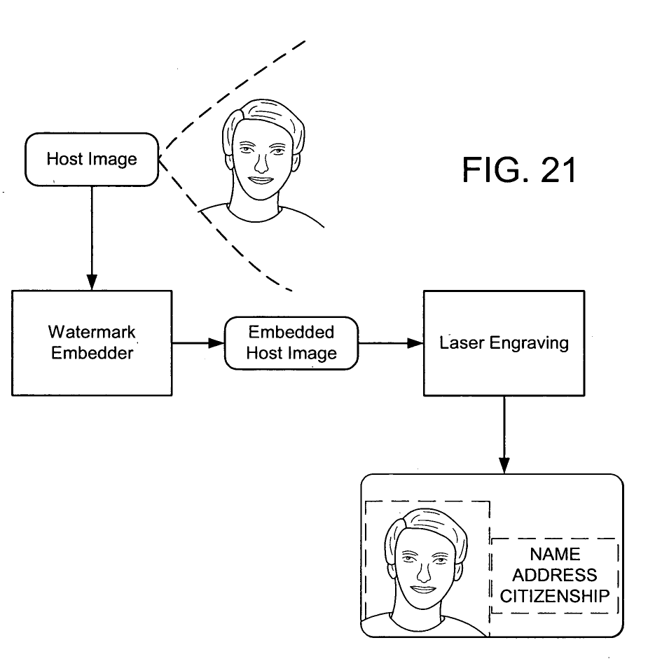

Digital watermarking with laser engraving is even further discussed with reference to FIG. 21. A host image (e.g., a grayscale image) is provided to a digital watermark embedder. The host image can be a portrait, e.g., as may be captured and used for a driver's license or passport, or a graphic, logo, pattern, line art, or background tint, etc. The digital watermark embedder embeds a digital watermark in the host image. In some preferred implementations the digital watermark includes a payload. The payload may include authentication clues as discussed below and in our patent documents referenced above. The digital watermark may also include a so-called orientation component, which is helpful is resolving image distortion such as rotation, scaling, translation, and/or helpful in watermark decoding. In some cases the watermark (or specific watermark components) is redundantly embedded throughout the host image. In other cases, the host image includes multiple watermark components, or separate, multiple watermarks, perhaps embedded using different embedding techniques or watermarking protocols. (In some implementations, multiple host images are communicated to the watermark embedder. A unique watermark (e.g., a watermark including a unique payload) is respectively embedded in each of the multiple images.).

The embedded host image (or images) is communicated to a laser engraving process. An identification document (or other document or object) is laser engraved to include the embedded host image (or embedded images). For example, the embedded host image may include a portrait, and the portrait is engraved into the document or document layer. In some implementations the embedded portrait (or other image) is engraved so as to achieve a so-called “ghost image.” A ghost image typically appears as a subtle representation much like a light background or overlay, which significantly increases the difficulty of altering a portrait or photo image. In some cases the identification document will include a laser enhancing additives to even better receiving the laser engraving. We note that a watermark can be laser engraved on an identification document including the laser enhancing additives. The enhancing additives help a layer better receive laser engraving.

Sometimes an over-laminate layer (or even a single or fused layer structure) will include a matte finish. The matte finish may be helpful in reducing visible artifacts associated with some forms of embedding.

Another security feature is that some laser engraving techniques provide a physical texture to a document surface (many other types of engraving do not provide such texture). A digital watermark can be conveyed via the surface micro-topology resulting from the engraving, or the textures may provide a tactile authentication clue.

In another digital watermarking implementation, we embed a digital watermark in a color image. The embedded color image is then laser engraved to an identification document (or other document or object). Full color laser engraving is even further discussed in our U.S. patent application Ser. No. 10/330,034, filed Dec. 24, 2002 (published as US 2003-0234292 A1), which documents are herein incorporated by reference. An inventive twist is that watermark components can be laser engraved in a color plane or even in different color planes. For example, a first digital watermark component is laser engraved in a yellow color plane, while a second digital watermark component is laser engraved in a cyan color plane, etc. Or an orientation component is engraved to be represented by a first color plane, while a payload or message is engraved so as to be represented by a second color plane. Our so-called K-Phase fragile watermarking techniques are particularly well suited for laser engraving with multiple colors. (See our PCT application No. PCT/US02/20832, published as WO 03/005291, which are each herein incorporated by reference.). Watermark components can be provided in color channels by selectively exciting dyes (e.g., via heat transferred from laser excited materials) contained in an identification document. To better illustrate, a document layer includes a first laser sensitive material. The material is sensitive in that it releases heat upon laser excitation. The released heat is transferred to a dye, which experiences a color transformation with the heat. In most cases the transformation is permanent. In some cases, a so-called pure or raw digital watermark signal is provided by selectively exciting dye to convey the pure or raw signal. In other cases a grayscale image is engraved in a single color plane.

Additional security may be added to an identification document by providing first and second digital watermarks. A first digital watermark can be embedded in a photograph or image (e.g., ghost image) carried on a document. The first image can be laser engraved on the document. The second digital watermark can be provided in a second, non-photograph region of the identification card. For example, the second digital watermark can be embedded in a background pattern or tint, line-art (see, e.g., assignee's U.S. Pat. No. 6,449,377) or in text, images or graphics carried by the identification document. The second watermark also may include an orientation component. (We note that the second watermark can be embedded using the same or different embedding protocol as the first watermark.). In some implementations the second digital watermark is laser engraved on the document. In other implementations only one of the first and second digital watermarks is conveyed via laser engraving.

The first digital watermark preferably includes a payload or message bits corresponding to a first set of information. The first set of information preferably relates to the holder of the identification card (hereafter “cardholder”) and/or to the issuing authority (e.g., state DMV or company) or jurisdiction. For example, the first set of information may include a unique identifier that is associated with the cardholder, date of birth, jurisdiction code, identification card number, name, address, physical characteristics (hair color, weight, sex, etc.), issue date, restrictions (e.g., age restrictions, driving limitations, etc.) and/or a hash (e.g., a reduced-bit representation) of such information.

The second digital watermark also includes a payload or message bits corresponding to a second set of information. The second set of information preferably corresponds with the first set of information

In one implementation, the second set of information corresponds exactly with the first set of information. The sets of information are compared to determine authenticity. In another implementation, the second set of information includes a subset of the first set of information. The subset is cross-correlated with the first set of information to determine authenticity. In still another implementation, the first set of information includes a key to decrypt the second set of information (or vise versa). (We note that an encrypted watermark may optionally be decrypted with a key contained in a watermark detector.). In yet another implementation, the second set of information includes at least some information that should correspond with information carried by a magnetic stripe or barcode. In another implementation, the second set of information includes both a subset of the first information and additional information. For example, the subset may include the birth date and document number, while the additional information may correspond with text printed on the document. Of course, many other combinations of related information can be provided. For example, the sets of information may be targeted to detect an age or name alteration (e.g., by including age or name information in both of the sets of information). In some cases the sets of information includes hashes or reduced bit representations of information pertaining to the cardholder or printed text information.

To authenticate the identification card, a watermark detector reads both watermarks. The first set of information and the second set of information are retrieved from each of the watermarks. (We note that typically only one optical scan is needed for detection when both the first and second watermarks are provided on the same surface of the identification document.). The first and second sets of information are compared to determine a match. If a match occurs, some or all of the watermark information may be providing to an inspector to facilitate a further check against text alteration. For example, both the date of birth and some data to verify against printed text (e.g., an indication that the 3^{rd} letter of the first name should be “e”, and the 2^{nd} letter of the last name should be “t”) can be provided to the inspector.

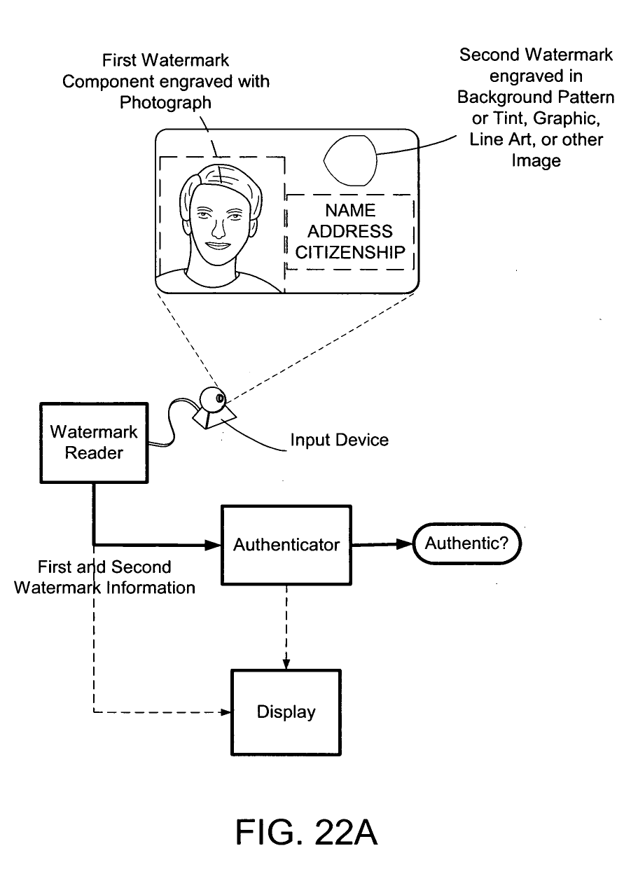

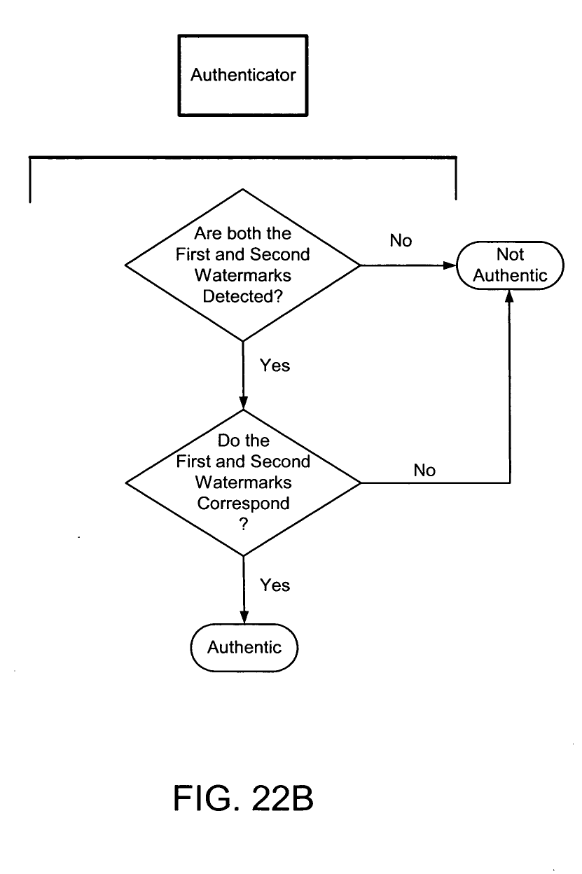

FIGS. 22A and 22B are diagrams illustrating a related authentication technique. An input device captures an image of an identification document. The identification document includes first and second digital watermarks, e.g., one or more of which are laser engraved thereon. The input device conveys data corresponding to a captured image to a watermark reader. The watermark reader can be realized as a programmable computer, which executes software instructions to detect and decode the first and second digital watermarks included in the captured image data. The computer can include a handheld device, laptop, desktop or remote server. (While the input device is illustrated as being tethered to the watermark detector/computer, the present invention also contemplates that the input device could wirelessly communicate with the computer instead.). The watermark reader passes decoded watermark information (e.g., payload or message information) to the authenticator. The authenticator can also be realized by software executing on a computer, and in some implementations, the watermark reader includes the authentication module. The authentication module determines whether the first and second watermark information corresponds. In an alternative implementation, the authenticator (or watermark reader) passes all or a portion of the watermark information to a computer display (e.g., a computer graphical user interface). Displaying some or all of the watermark information allows an inspector or officer to visually compare the watermark information against information printed on the document. The authenticator outputs an authentication signal to indicate the authentication status of the identification document. In some cases the signal is conveyed to the display. Here, the authentication signal can be a simple pass or fail signal, or a more detailed response indicating the reason for the failure. In other cases the signal is conveyed to an audio output device (e.g., audio speaker) to audibly signal the authentication status (e.g., a predetermined sound or audio segment is output if authentic, while another predetermined sound or audio segment is output is not authentic).

The authentication module is further discussed with reference to FIG. 22B. The identification document is considered authentic when both the first and second digital watermarks are recovered and when the first and second watermark information (e.g., sets of information) correspond. The document is considered not authentic when either of these criteria is not met.

We note that this implementation is generally issuing source and card neutral. This means that a first and second digital watermark can be used to verify an identification document regardless of the features provided on the card.

As an alternative implementation, a second digital watermark is laser engraved on a different document surface (e.g., the back side of the document) than the first digital watermark. We note that this alternative implementation may require two optical scans to detect both the first and second digital watermarks. This may be less of an issue when the second digital watermark includes information that is used for forensic tracking purposes. For example, the watermark may include information that is tied to the original cardholder. If the second watermark is copied and transferred to a second identification document, the watermark information can be used to trace back to the original cardholder. Similarly, the second watermark may include information pertaining to the issuing location (e.g., which DMV branch office) or original issuing officer.

A fragile or semi-fragile watermark is provided to any of the first and second embodiment implementation as either a watermark replacement or to augment the above implementations. For example a fragile watermark may be used as either a first or second watermark or as a third watermark component. In some implementations we preferably use our out-of-phase embedding techniques, e.g., as disclosed in PCT/US02/20832, to embed a fragile watermark. It will be appreciated that a fragile watermark is designed to be destroyed or to predictably degrade upon signal processing. A semi-fragile watermark is designed to withstand normal signal processing, but is destroyed or predictably degrades upon malicious attacks.

The addition of a fragile or semi-fragile watermark adds protection against anticipated fraud scenarios by providing alerts when copies are made. Alteration in conjunction with card copying can be detected from the absence or condition of the fragile watermark.

In another implementation we provide a machine-readable link to related information. The machine-readable link is preferably provided via a digital watermark payload or identifier. The identifier can include a unique number that is used to interrogate a database or access a remote resource. In some cases the identifier includes a URL or a code that is used to access an appropriate URL. In a driver's license scenario, a digital watermark includes a link to an insurance database. The database includes data records evidencing that a cardholder does or does not have car insurance. In other cases, the digital watermark includes a link to a DMV database, to allow verification of information printed on the identification document, and perhaps a photograph of the cardholder. The database cardholder can be compared against the person presently holding the card. A “photo swap” can be further detected from comparison of a database photograph with a photograph carried on the card and a visual inspection of the current cardholder. The techniques discussed in assignees' U.S. patent application Ser. No. 09/571,422, filed May 15, 2000, and in U.S. Pat. No. 6,408,331 can be suitable interchanged with this linking aspect of the present invention.

A few possible combination, in addition to those discussed above, shown in the drawings and in the accompanying claims, include:

A1. An identification document, comprising:

a core layer;

a first layer overlaying at least a portion of the core layer and affixed to the portion of the core layer, the first layer comprising laser engraving therein, the laser engraving conveying a first digital watermark including a plural-bit payload.

A2. The identification document of A1, wherein the laser engraving comprises at least a second digital watermark.

A3. The identification document of A2, wherein the first and second digital watermarks cooperate to facilitate authentication of the identification document.

A4. The identification document of A1, wherein the laser engraving comprising a photographic representation of a bearer of the identification document, and wherein the first digital watermark is embedded in the photographic representation.

A5. The identification document of A4, wherein the photographic representation is a grayscale image.

A6. The identification document of A4, wherein the photographic representation is a color image.

A7. The identification document of A1, wherein the engraving does not penetrate the first surface.

A8. The identification document of A1, wherein the engraving does not through the core.

B1. A digital watermarking method to digitally watermark an identification document comprising:

providing at least a first color dye in a document layer, the first color dye experiencing a transformation upon excitation;

providing at least a first sensitive material in proximity of the first color dye; and

exciting the first sensitive material with a laser to selectively excite the first color dye in a manner to convey a first digital watermark.

B2. The method of B1, wherein the laser causes the first sensitive material to release heat.

B3. The method of B 1, wherein the released heat excites the first color dye so as to experience a color transformation.

B4. The method of B 1, further comprising:

providing at least a second color dye in the document layer, the second color dye experiencing a transformation upon excitation;

providing at least a second sensitive material in proximity of the second color dye; and

exciting the second sensitive material with a laser to excite the second color dye in a manner to convey a second digital watermark component.

C1. An identification document comprising

a core adhesively bound to,

an imaging layer comprising a mixture including a first color dye, the first color dye experiencing a transformation upon excitation, and a first sensitive material, wherein exciting the first sensitive material with a laser excites the first color dye in a manner to convey a digital watermark.

D1. A digital watermarking method comprising:

providing a host image;

digitally watermarking the host image;

providing the watermarked host image to a laser engraving apparatus; and

laser engraving a document or object so as to represent the watermarked host image.

D2. The method of D1 wherein the document comprises an identification document.

D3. The method of claim D1, wherein the host image comprises a color image.

Metallic and Other Shinny Surfaces

Our above camera and camera attachment works well with watermarked images or objects laser engraved on shiny surfaces, e.g., steel, metal, high-gloss, aluminum, alloys, etc. Example engraving surface may include, e.g., golf clubs, metal surfaces, guns, watches, jewelry, metal foils, tools and tooling, plates, labels, parts and components, objects, etc. The images include digital watermark embedded therein. The watermarked image is used as a master to guide laser engraving.

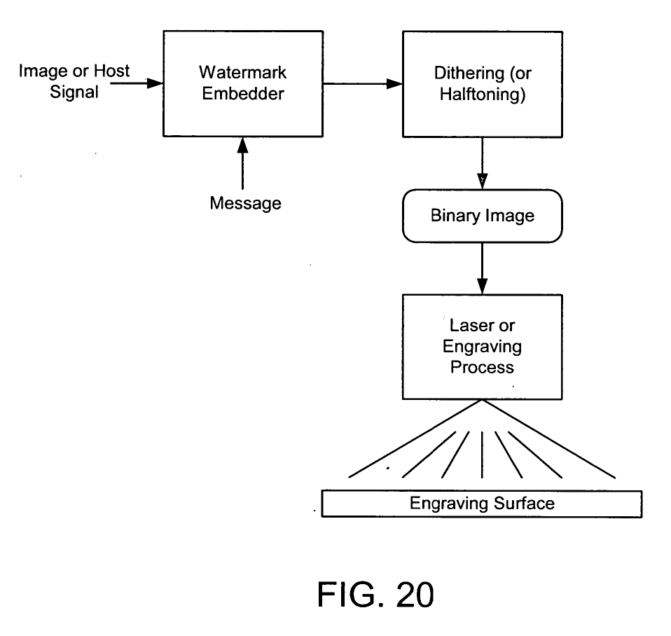

An alternative embedding and engraving process is shown in FIG. 20. A digital watermark embedder embeds a digital watermark in a host signal (e.g., image). The embedder receives as inputs a host signal (e.g., image) and message. An embedded digital watermark may include an orientation component. A dithering process (e.g., a halftoning process as provided by Adobe's PhotoShop) dithers the embedded image. The dithering process produces or yields a thresholded or binary image (e.g., a binary image is generally represented by “on” or “off” pixels). We have found that the binary image sufficiently includes the digital watermark embedded therein. The binary image is used to guide laser engraving on a metallic or other shinny surface. A resulting engraved image includes the digital watermark embedded therein.

A few possible combination in addition to those discussed above, shown in the drawings and in the accompanying claims, include:

A1. A method to analyze optically captured steganographic indicia provided on a metallic or specular surface comprising:

Receiving captured image data including a reflection of a lightly colored surface from the metallic or specular surface, wherein the reflection has disposed therein relatively dark areas corresponding to the steganographic indicia; and

analyzing the image data to recover the steganographic indicia.

A2. The method of A1, wherein the steganographic indicia comprises digital watermarking.

B1. A laser engraving method comprising:

receiving an image whose pixel values are represented in a binary fashion, wherein the image includes a digital watermark embedded therein; and

laser engraving the image on at least one of a metallic surface and metal-alloy surface.

C1. A method comprising:

receiving an image that includes a pixels represented in a binary fashion, wherein the image includes a digital watermark embedded therein, and wherein the image corresponds to at least one of a grayscale image and color image, and wherein the digital watermark was previously embedded in the grayscale image or color image, but survived a dithering process which yielded the image; and

guiding laser engraving with the image.

Copy Detection Watermarks Using Metallic Inks

Inks are available that have a metallic or metallic-like finish. Some of these metallic inks may provide a so-called specular (or mirror-like) finish. As was discussed above with respect to FIG. 2, a specular surface generally reflects light away from (and not generally back to) the light's source. In one implementation, a specular surface reflects light in a directional manner such that the light's angle of reflection is approximately equal to its angle of incidence.

We provide a copy-detect digital watermark (or steganographic marking) using metallic ink. A so-called “copy detect” watermark includes characteristics or features that are useful in determining a copy from an original. The copy detect characteristics may result from signal or frequency properties, and/or may result from a medium (e.g., ink) used to convey the watermark signal.

There are a variety of suitable conventional metallic inks. Some of these inks include tiny, perhaps even microscopic, “flakes”. The flakes possess, e.g., a smooth surface that imparts high specular reflection with little diffusion of reflected light. Several metallic inks are made by MD-Both Industries, with an office in Ashland, Mass. USA, under the tradenames Mirasheen™ Silver Vacuum-Metallized Inks and Metasheen™ Vacuum-Metallized Finished Inks. Of course there are many other metallic inks that can be suitably interchanged with this aspect of the present invention. And, we envision that such metallic inks can be applied through conventional means including, e.g., process color printers and printing processes.

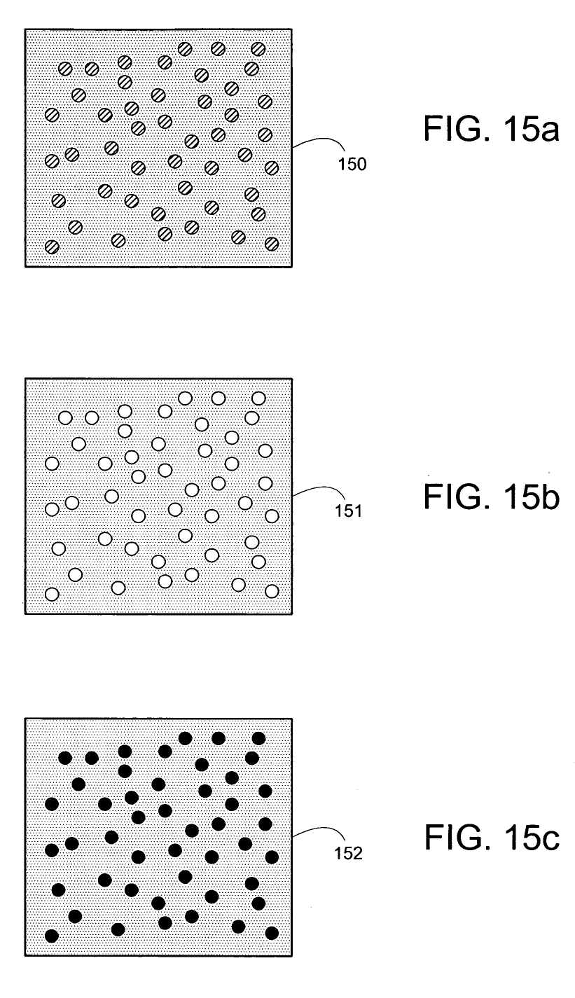

With reference to FIG. 15a we provide a steganographic marking, e.g., a digital watermark, on a physical document 150. The physical document can include, e.g., a graphic, logo, identification document, security document, product tag or packaging, label, check, sticker, banknote, image, photograph, printed document, etc., etc. In FIG. 15a, the steganographic signal is represented by a plurality of “hashed circles”. (In practice, however, the steganographic signal will be applied through conventional printing methods, e.g., halftone dots. The steganographic marking in FIG. 15a has been exaggerated to ease the following discussion.) The steganographic marking is preferably subtle, e.g., a human viewer of the marking would not necessary appreciate that the marking conveys a plural-bit message or text. In some implementations the marking will appear as a subtle texture or background tint/pattern. In most implementations we prefer to camouflage or blend-in the steganographic marking with printing or coloration found in the printed document. For example, if the document's background or an adjacent area includes a red coloration, we can apply our steganographic marking with a similarly colored red metallic ink. Or if the document's background or an adjacent area includes a black coloration, we can apply a steganographic signal using gray or black colored metallic ink.

The steganographic marking preferably includes a message or payload. A steganographic encoder will typically manipulate a message prior to embedding or hiding (e.g., binary message bits can be converted into a series of binary raw bits, the message can be error correction encoded and/or spread spectrum modulated, etc., etc.). After encoding, a resulting message will preferably include a positive or negative polarity. See, e.g., assignee's U.S. Pat. No. 6,614,914.

A steganographic marking will also preferably include an orientation component. An orientation component is useful, e.g., in resolving image distortion such as scaling, rotation and translation. See, e.g., assignee's U.S. Pat. No. 6,614,914.

The steganographic encoder may combine an encoded (and perhaps modulated) message and an orientation component or may provide the message and orientation component as separate signals. Collectively, however, the message and orientation component can be provided as a pure or raw steganographic signal. (In some implementations we “embedded” the message and orientation signal in a flat gray image, and the embedded, flat gray image is provided as the pure or raw signal. In other implementations we provide a spatial domain representation of the message and orientation component.) In a spatial domain, the pure or raw signal may be visually perceptible as a subtle texture, tint, pattern or noise-like signal. (In some case we threshold this pure or raw signal to create a thresholded pure or raw signal.)

We preferably use this pure or raw signal (or a thresholded version of such) to guide our printing of metallic ink on the physical document 150. We represent relative contrast (e.g., lighter areas vs. darker areas) of the pure or raw signal through placement of more or less metallic ink on the physical document. For example, we can apply relatively more metallic ink to represent lighter areas of the signal, and relatively less metallic ink to represent darker areas of the signal. Placement of ink is simplified when the pure or raw signal comprises a binary image, with white and black areas. Metallic ink can be applied to represent, e.g., the white areas, and no metallic ink is applied to represent the black areas.

A decoder can use the relative changes in contrast across the printed document to recover the steganographic signal. For example, if such a printed document is thereafter scanned by a scanner (e.g., as discussed below with reference to FIG. 15b), the values of pixel data produced by the scanner will reflect the foregoing alterations in contrast (e.g., in terms of luminance values), permitting the steganographic signal to be decoded.

The copy detection features of this aspect of the invention are now discussed with reference to FIG. 15b and FIG. 15c.

FIG. 15b represents an optically captured image 151 corresponding to the document 150 in FIG. 15a. The optical image 151 is captured, e.g., using a device like the camera discussed above that includes a reflective sleeve or favorably-colored surface (e.g., surface 92 and/or 94 as in FIG. 9). For example the sleeve or surface includes a white coloration. From the camera's (or camera lens) perspective, the metallic ink reflects the surface coloration (e.g., white). The metallic ink then appears white or lighter in contrast to the document's background or adjacent areas from the camera's perspective. A steganographic decoder analyzes image data corresponding to the optical image 151 to detect and decode the steganographic message. (For example, the decoder may use the relative contrast between the white areas corresponding to the metallic ink and the document's background or adjacent areas to decode the signal.).

FIG. 15c represents, e.g., an unauthorized or counterfeit copy of the original document 151. The copy is created, e.g., using a conventional image capture device (e.g., a flatbed scanner) and then reprinting the captured image on a color printer. A flatbed scanner will generally not include a favorably-colored surface (e.g., like surface 92 and/or 94) positioned with respect to a lens assembly 84a, as in FIG. 9. Instead flatbed's optical sensor will be positioned directly below the metallic ink, without a surrounding or adjacent favorably-colored surface. Consequently, the specular surfaces of the metallic ink will reflect light away from the optical sensor (much like is shown in FIG. 2). A copy will then have dark voids or black areas that corresponding to the metallic ink—essentially reversing the relative contrast between the metallic ink and the document's background or adjacent areas. In many cases, these dark voids will be subtle, perhaps being unrecognizable by an unaided eye.

To determine whether the copy 152 (FIG. 15c) is genuine or a copy we optically capture an image of the copy 152, e.g., using an imaging technique as discussed above with respect to FIG. 15b. The captured image will appear very similar to the FIG. 15c representation. A steganographic decoder analyzes the captured image and recognizes the copy. Remember that we deliberately choose to represent “lighter” areas of the signal with more metallic ink—resulting in light areas in an image captured according to FIG. 15b. But, in the case of the copy, the lighter areas of the steganographic signal are now represented with black areas or voids. Thus, the copy includes a reversed contrast representation, which results in a reversal in message or watermark signal polarity. (The term “polarity” in this context has a broad definition and may include, e.g., a representation of contrast for a watermark signal relative to a host signal, a representation of host signal adjustments needed to accommodate a watermark signal, a representation of watermark signal characteristics, and a representation of watermark signal characteristics relative to host signal characteristics.). The steganographic decoder may not be able to read the message due to this polarity reversal. More likely, however, is that the steganographic decoder recognizes that the message is represented with a reverse polarity. The recognition of a polarity reversal can signal a counterfeit or copy.

A steganographic decoder will generally be able to detect the orientation component, e.g., when using a frequency domain-based detection scheme (which is polarity independent). In one implementation, a detection of an orientation component, but a failure to read the message, signals a copy.

(In an alternative implementation, we provide metallic ink on physical document to correspond with relatively dark areas or portions of a pure or raw steganographic signal. We apply less or no ink to represent light areas. In this case, an image captured using the FIG. 15b techniques will now have the so-called reverse polarity. But, since we expect the reverse polarity for an original, we are not surprised. A copy, however, will have the normal polarity. A copy is determined when the normal polarity is found.) A few possible combinations, in addition to those discussed above and found in the claims, are as follows:

A1. A copy detection method comprising:

receiving optically captured data representing at least a portion of an object, wherein the object includes steganographic indicia conveying a signal having a first signal polarity, wherein the optically captured data includes a representation of the steganographic indicia;

analyzing the representation of the steganographic indicia to determine the first signal polarity;

comparing the first signal polarity with an expected signal polarity; and

if the first signal polarity and the expected signal polarity do not coincide in an expected manner, determining that the object is a copy.

A2. An apparatus including memory and electronic processing circuitry, the memory including instructions for execution on the electronic processing circuitry, the instructions including instructions to perform the method of A1.

A3. The combination of A1 or A2, wherein the steganographic indicia comprises digital watermarking.

A4. A computer readable medium having instructions stored thereon for performing the method of A1.

A5. The method of A1, wherein the first signal polarity comprises a representation of signal contrast.

A6. The method of A5, wherein the first signal polarity comprises a representation of signal contrast of the steganographic indicia relative to at least a portion of the object or indicia thereon.

Domes and Print and Peel

We have found that we can provide a steganographically-encoded image with a protective dome. For example, we can provide an epoxy or polyurethane dome covering a steganographically encoded photo, label, pin, medallion, name plate, etc. Suitable covering materials are provided, e.g., by Epoxies, etc. located in Cranston, R.I. USA (e.g., under the trade names Deco-Coat 2501, Deco-Coat 2550 and DECO-COAT 2510, etc.). Suitable epoxy resins can be obtained from, e.g., Gotrax Polymers Inc in Cobourg, Ontario, Canada (e.g., under the trade name AcuDOME). Of course there are many other suitable materials and products.

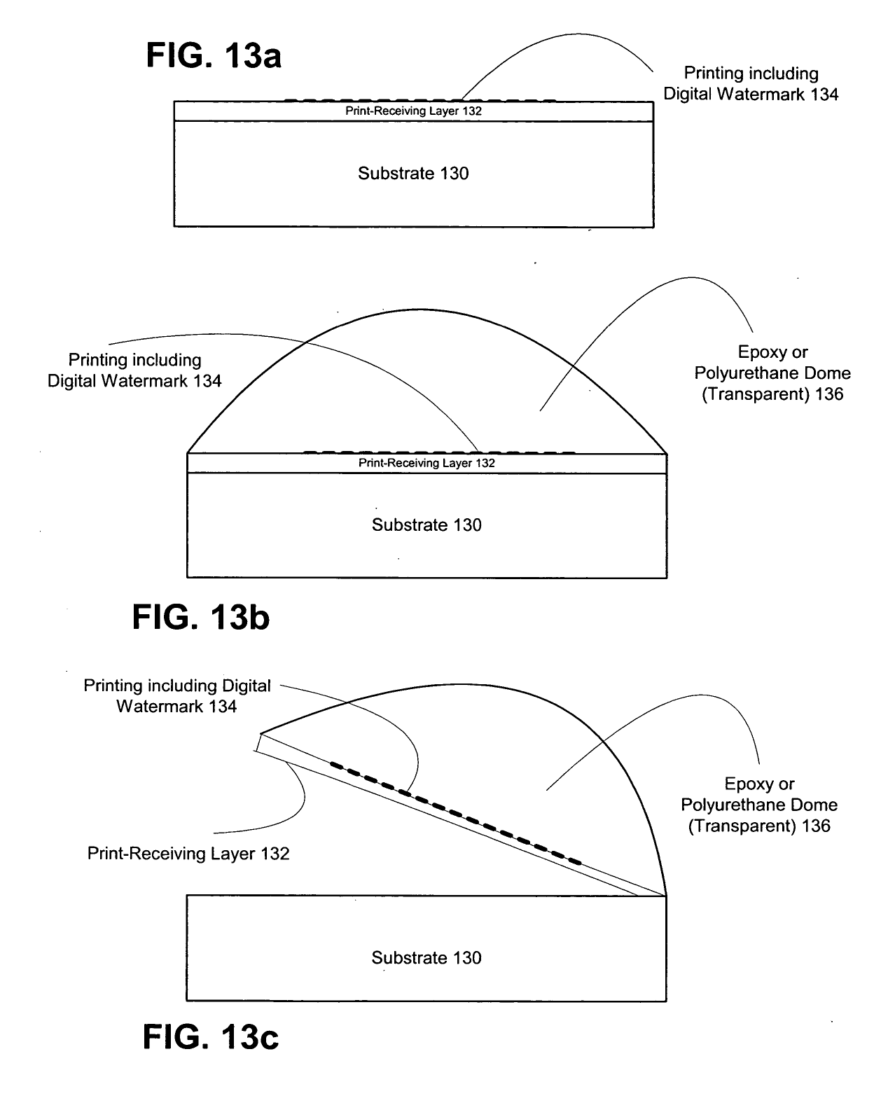

In a related implementation, with reference to FIGS. 13a-13c, we provide a substrate or carrier 130 like a thin film or sheet of paper, polycarbonate, Teslin® (TESLIN is a synthetic sold by PPG Industries, Inc., One PPG Place, Pittsburgh, Pa. 15272 USA), Mylar, aluminum, wax coated paper, etc., etc. The substrate 130 preferably includes a print-receiving layer 132 (FIG. 13a). In some cases, a polymer (e.g., PVC) is used to form a print-receiving layer. In other cases we use a vinyl-based print-receiving layer, or even satin finish layer. One example of a suitable substrate having print-receiving layer is HYAZ Inkjet Media products, supplied by HYAZ in Rhome, Tex. USA. Of course there are other suitable products as well.

We provide printing 134 on the print-receiving layer. The printing 134 preferably includes steganographic data encoded therein. The encoding comprises a digital watermark in our preferred implementation. The printing is covered with a transparent laminate 136, e.g., such as an epoxy or polyurethane dome. The laminate 136 securely affixes or adheres to the print-receiving layer 132.

An inventive aspect of this embodiment is that the print-receiving layer 132 and the substrate 130 are readily separable. That is to say, with reference to FIG. 13c, we can peel or separate the laminate 136 (along with the printed, print-receiving layer 132) away from the substrate 130.

Once removed from the substrate 130, the laminate 136/printed, print-receiving material 132 structure can be applied to objects or substrates, perhaps with an adhesive. We envision this type of steganographically-encoded structure being applied to metals, plastics, synthetics, paper, etc.

Over-Lay Including Watermark Key

Another inventive aspect of the present invention is disclosed with reference to FIGS. 14a and 14b. FIG. 14a illustrates an identification document 140 including a photographic representation 142 of a bearer of the document and, preferably, information 144 associated with the bearer of the document printed thereon. The information 144 may include, e.g., the bearer's name, age, driving address and/or citizenship etc. The information 144 may be printed as shown or may be stored in a barcode, magnetic stripe, optical memory or electronic memory circuits (e.g., as common in so-called smart cards). Of course there are many other types of documents that will benefit from the following techniques, including passports, visas, drivers licenses, identification cards or badges, company cards, legal documents, bank notes, security documents, labels, tags, logos, printed documents, product packaging, etc., etc. Of course, information typically associated with such documents can be respectively placed as information 144 thereon.

The identification document 140 preferably includes first steganographic data encoded thereon. For example, the photograph 142 may include a first digital watermark embedded therein. Or the identification document 140 may include a background pattern, tint or graphic, etc., and the pattern, tint and/or graphic may include the first steganographic data hidden therein.

The first digital watermark (or first steganographic data) is preferably encoded, embedded, created and/or encrypted according to a key or according to a plurality of keys. Thus, decoding or decrypting the first digital watermark requires a corresponding key or keys. The digital watermark remains “locked” or irretrievable without the appropriate key or keys.

Now with reference to FIG. 14b, an over-lay 146 is provided to assist with the decoding or decryption of the first digital watermark encoded on the identification document 140. (We note that our over-lay 146 will generally not be a layer of the document 140 itself. Rather, the over-lay 146 will be selectively, and temporarily, placed against the document 140 by one with authority. We imagine that distribution of the over-lay 146 will be closely restricted.). The over-lay 146 is preferably transparent or semi-transparent, so as to allow optical detection of the identification document 140 through the over-lay 146. The over-lay 146 includes machine-readable indicia thereon, e.g., a second digital watermark or second steganographic data. The machine-readable indicia is preferably steganographic such as a subtle tint or pattern, provided, e.g., with printing or laser engraving on a top or bottom surface of the over-lay. Or if a graphic or image is provided on the overlay, the graphic or image can be embedded with a digital watermark or steganographic data. (While not our preferred embodiment, in some implementations the machine-readable indicia comprises a barcode (such as a 2-D barcode) or other visible machine-readable code. But such visible codes are inherently perceptible and can be targeted by a would-be counterfeiter or thief.).

The over-lay's machine-readable indicia includes a key to unlock or decode the first digital watermark (or first steganographic data). For example, the decoding key may include a decryption key if the first digital watermark includes an encrypted payload or message. Or the key may include an indication of which watermarking protocol was used to encode the first digital watermark or even the location or expected orientation of the first digital watermark. In some implementations, the over-lay 146 is carefully positioned over the identification document 140. In these implementations, the first digital watermark signal includes just a message or payload, while the over-lay's machine-readable indicia includes a so-called orientation component which is used to orient or locate the message or payload.

In still other implementations the machine-readable indicia includes a clearance level indicator. The indicator may include a specific key or decryption code. The indicator then determines which out of a plurality of information hidden on the identification document 140 someone may access. For example, a bouncer at a nightclub may have an over-lay including a first clearance level indicator. The first clearance level indicator provides a key, which is able to unlock or decode a first set of information carried by the first digital watermark on an identification document 140. The first set of information may include, e.g., the bearer's age and name, but not an address, identification number or phone number. This approach provides some level of anonymity for the bearer. The nightclub bouncer verifies the bearer's age (i.e., that she is over 21 years old), but without accessing other, perhaps more private information that may be carried by the first digital watermark. In contrast, a police officer may include a second over-lay including a second clearance level indicator. The second clearance indicator is placed over the bearer's identification document. The second clearance indicator provides a second key, perhaps even a master key, which can be used to access all information carried by the first digital watermark. The first digital watermark information may include the bearer's address, age, identification number, perhaps even parole information or civil or criminal restrictions.

A variable clearance level implementation can be achieved using many different approaches. For example, we can provide multiple digital watermark layers on the identification document 140. In this context a “layer” implies a distinct watermarking protocol, or a layer may indicate a separate watermark payload. In other cases a layer represents a field within a payload—perhaps with each layer (or field) being encrypted differently using different encryption keys, etc. Different over-lays are then able to access different watermark layers according to their clearance indicators.

Since the transparent over-lay 146 is intended to be provided over the identification document 140, a single image of the overlay and document will generally capture both the machine-readable indicia and the first steganographic data. The key, once recovered from the machine-readable indicia will then be used to unlock or decode the first digital watermark (or first steganographic data). (Of course, we also imagine an implementation where an image of the over-lay is first optically captured, and then an image of the identification document 146 is captured.).

Thus, the machine-readable indicia (e.g., a digital watermark) of the over-lay 146 provides access to the information carried by the first digital watermark (or first steganographic data) encoded in the identification document 140. Our technique is perhaps analogous to a security dongle of sorts. But here, instead of providing a computer hardware plug-in to access a computer, our over-lay 146 provides access to another document 140 by providing a key or authorization code.

While the over-lay in FIG. 14b is illustrated as being the same size as document 140, the present invention is not so limited. Indeed, the over-lay can be larger or smaller than the document 140. And, instead of an overlay, the separate machine-readable feature can be provided with a lens (or lens filter). For example, a lens can be engraved or textured in such a manner as to convey a machine-readable component. This machine-readable component can be used to unlock or find a machine-readable feature on a object.

Image Capture System for Portable Device and Watermarking Logos and Graphical Icons

Digital cameras are becoming an increasing popular feature of portable electronic devices, such as wireless telephones, Personal Digital Assistants (PDAs), etc. These digital cameras are typically used to capture still pictures or video clips. While these uses of digital cameras in portable devices have gained some acceptance, there is an increasing demand to expand the functionality of the device beyond these simple image capture applications.

As evidenced by the wide array of image capture devices in use today, there are a wide array of uses and corresponding configurations of these devices. Some examples include video cameras, web cameras, digital still image cameras, document scanners, fax machines, bar code and other graphic symbology readers, digital watermark readers, fingerprint capture devices, handwritten signature pads, iris/retinal scanning devices, etc. It would be advantageous to incorporate some of this functionality into the camera systems in portable devices, such as wireless telephones. However, the physical size, memory and processing constraints of portable devices make it difficult to incorporate many different image capture and processing applications into the portable devices. Cell phones with cameras present a particularly difficult design challenge because consumers demand a compact design so that the telephone easily fits in ones hand and pocket.

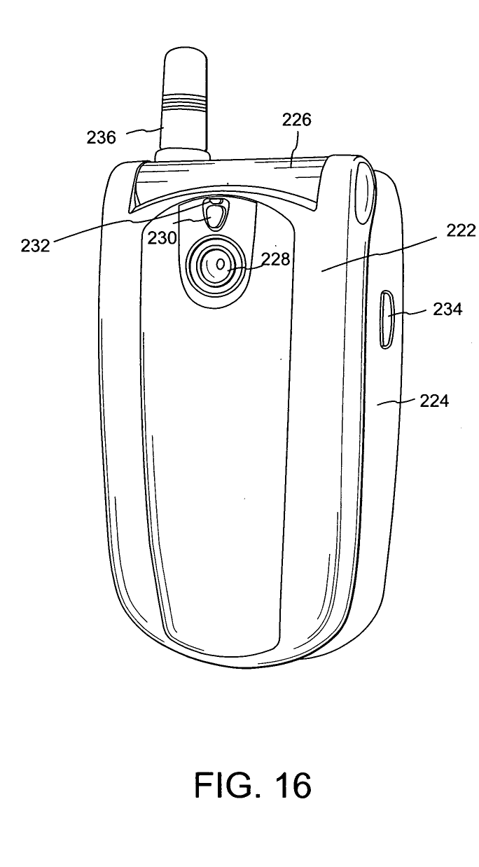

FIG. 16 is a diagram of a wireless telephone with a multi-mode image capture system for reading and processing images captured at different focal lengths. In this example, the wireless telephone 220 has a “flip phone” configuration with a top and bottom enclosures 222, 224 connected via a hinge 226. Mounted within the top enclosure, the telephone includes a camera with an exposed lens 228, a contact switch 230, and illumination source 232, such as a Light Emitting Diode (LED) or configuration of LEDs. The enclosure of the telephone also includes one or more input controls, such as the push button 234 on the side of the bottom enclosure. The wireless phone also includes an RF transceiver system and antennae 236 for transmitting and receiving wireless communication signals.

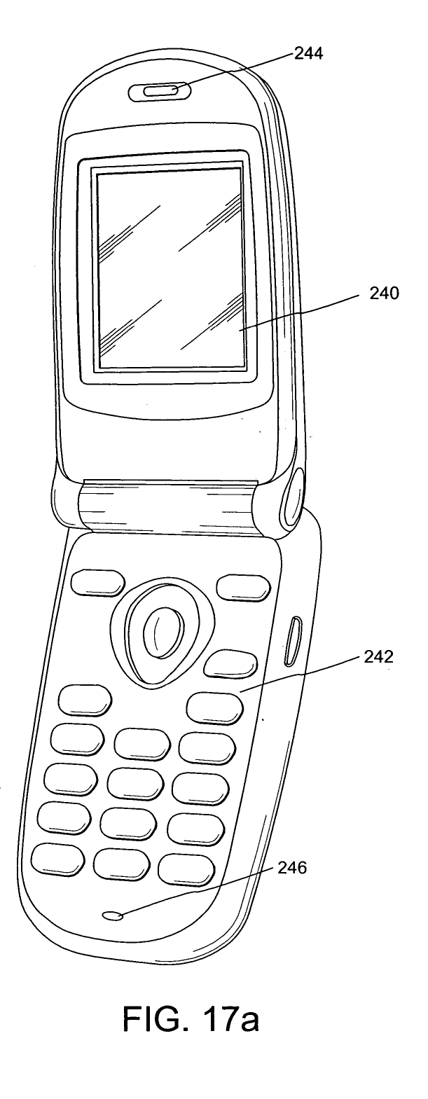

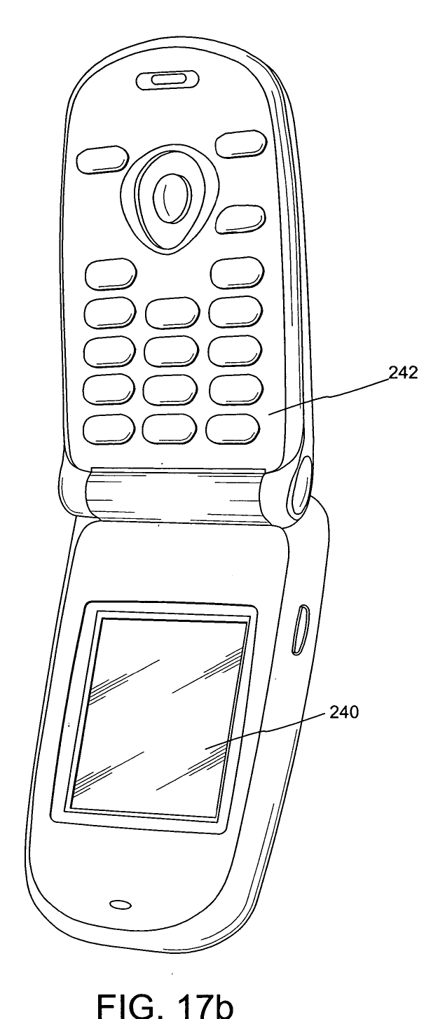

FIG. 17a is a diagram of the telephone in FIG. 16 in an open position. This position reveals a video display 240 in the top enclosure and a keypad 242 in the bottom enclosure. The top enclosure also includes a speaker 244, while the bottom enclosure includes a microphone 246. The video display and keypad positions can be swapped. Similarly, the microphone and speaker positions can be swapped. (FIG. 17b illustrates an example of this swapped configuration.) The video display and keypad form the user interface of the telephone. The video display shows menu options, telephone numbers, system settings, and other information used in controlling the telephone. It also displays images captured from the camera.

When the video display is on the same half of the enclosure (either top or bottom enclosure) as the camera, the user can set the camera side of the open phone on a target object for image capture, and look down on the video display over the object to see a picture of the object on the display. This positioning of the camera and video display assists the user in targeting an image for image capture by enabling the user to view a displayed image of the target object under the phone.

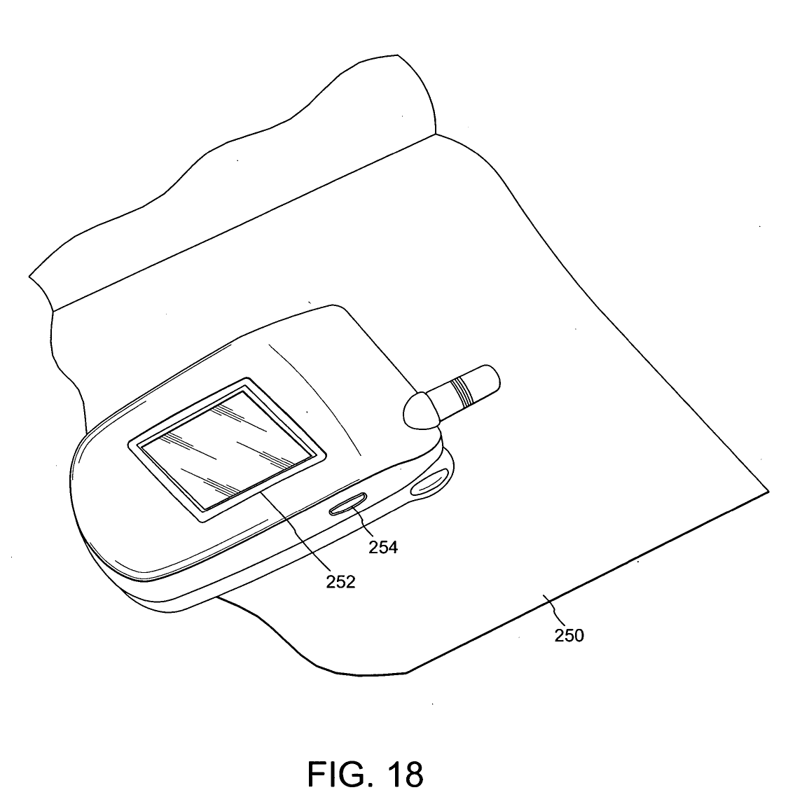

FIG. 18 is a diagram of the telephone in a closed position. In this position, the lens of the camera points at a target object 250 upon which the bottom enclosure is resting. In this case, the object is a document, such as a page from a book or magazine, piece of mail, or other printed material. The telephone optionally includes a display 252 (perhaps an additional display) on the outer part of the enclosure to enable the user to view images captured by the camera while the telephone is closed. This use of the display facilitates targeting of the camera at a particular object by enabling the user to see what is being captured. The display may also be used to display phone menu options and information while the telephone is closed. FIG. 18 also shows another example of a user control 254, such as a button, on the side of the enclosure. This can be used to control the camera (e.g., snap a picture, or begin and end a video stream capture, each with a press of the button) or other functions of the telephone depending on its operating mode.

As noted in connection with FIG. 17b, a user can place a version of this telephone on a target object when the phone is in an open position and use the inner display to target objects for image capture. The display can even show cross hairs or other marking lines or graphics as well as camera status information to assist the user in correctly scanning images of objects with the camera. It is not necessary to have displays on the inside and outside of the telephone. Alternatively, the enclosures can be connected via a twisting and pivoting mechanism to enable the user to pivot open the phone on a first hinge, and then twist the display side of the disclosure on a second hinge to a desired angle so that the larger display inside the phone can be used as a view finder for image capture with the camera.

The camera depicted in FIGS. 16-18 is designed to have multiple image capture modes for different imaging applications. These modes include a normal camera mode for capturing images of objects at longer focal distances, and a close up mode for capturing images of objects at shorter focal distances. Close up mode can be used for applications like object inspection or magnification, document scanning, machine readable code scanning (e.g., bar code, glyph, digital watermark, etc.), biometric image capture, etc. An example of close up mode is shown in FIG. 18, where the enclosure housing the camera is placed on a target object for image scanning. Examples of normal camera mode include the configuration of FIG. 17a or 17b, where the user points the camera at objects farther away and views captured images of those objects on the display. Another example of normal camera mode is when the camera is closed as in FIG. 18, yet pointed at objects farther away, unlike the close up object depicted in FIG. 18.

The lens and camera need not be positioned in the telephone as shown in the illustrated examples. They can be placed in other convenient locations to facilitate use of the camera in different operational modes, such as close up and normal. For example, another possible configuration is to place the camera in the barrel of the hinge (e.g., hinge 226 in FIG. 16) between the top and bottom enclosures. This configuration enables video camera functionality when combined with a twisting display panel allowing the user to point the barrel at a target object while viewing the captured images on the display panel. The position of the enclosure: e.g., twisted or untwisted, open or closed, can be used to select the mode of the camera, e.g., normal or close up.

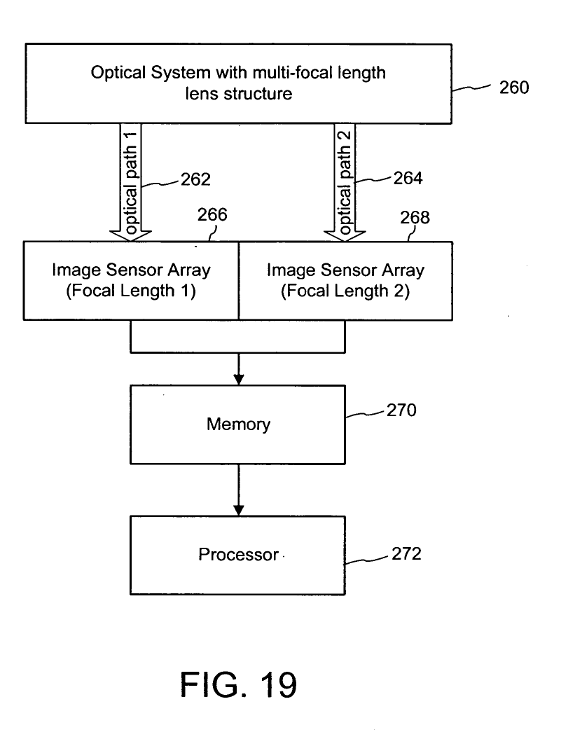

FIG. 19 is a diagram of an image capture system with two or more modes of operation. This particular system is used in the wireless telephone shown in FIGS. 16-18, and can be used in other portable devices as well. This system includes an optical sub-system 260 with multi-focal length lens structure. In one particular implementation, the lens in this subsystem is bi-focal, meaning that it focuses light at two different focal lengths. This attribute of the lens creates two optical paths 262 and 264, each directed to an image sensor array 266, 268. The image sensor arrays 266, 268 are implemented by partitioning a larger image sensor array into sections, where one section of the array receives light from one optical path, and the other section receives light from the other optical paths. In particular, rather than using 640×280 pixel array size (e.g., VGA compatible) as is typical in current camera-enabled wireless cell phones, our implementation uses a larger array (e.g., 1.3 or 4 megapixel) that is partitioned into two sections, one for each optical path. The preferred type of image sensor is a CMOS sensor, but other alternatives, such as CCD sensors, may be used as well.

The optical subsystem may have more than two paths. These paths may be created from a lens with multiple focal lengths, or from separate lenses, each having different focal lengths.

An objective of designing the optical system with two or more optical paths at different focal lengths is to enable a wide variety of applications including some requiring longer/variable focal lengths, and some requiring shorter/fixed focal lengths. For example, applications that benefit from longer or variable focal distances is normal video or still picture image capture of fixed or moving objects at a range of a few to several feet. In contrast, applications benefiting from shorter or fixed focal distance image capture include object inspection or magnification, document scanning, machine readable code scanning (e.g., bar code, glyph, digital watermark, etc.), biometric image capture, etc.

To support close up mode, one of the optical paths captures images at a short focal length (e.g., the distance between the lens and the object upon which the telephone enclosure is resting as shown in FIG. 18). To support normal mode, one of the optical paths captures image at longer focal lengths. The longer focal range of normal mode is preferably optimized for “landscape mode” consistent with typical digital still and video cameras.

In one implementation, the image capture system simultaneously captures images at the different focal lengths on the image sensor arrays 266, 268. These images are transferred to memory 270. The memory may be video RAM memory or part of general purpose RAM memory used for other data.

The images are processed using special purpose and/or general purpose hardware. These hardware functions are encapsulated in the processor 272 in FIG. 19. In one implementation for cell phones and other portable devices, the processor comprises an X-Scale processor from Intel Corporation. Other processor configurations are possible, including microprocessors, microcontrollers, Digital Signal Processors, ASICs and combinations thereof.

In our cell phone implementation, driver software enables applications to access the images captured from the different image sensor arrays 266, 268. This software implements a sub-windowing function that enables application programs executing in the system to selectively access the image streams captured by the image sensor arrays. This enables the programs to get the advantages of both streams, switch back and forth as needed, or access both simultaneously, in cases where the processor and operating system support multi-tasking or multi-threading program execution.

The image stream for longer or variable focal distances can be used for targeting an object for image capture. For example, the object can be displayed in normal mode on one of the telephones displays, acting as a view finder for the user. Application programs requiring the image stream in close up mode can then access the other stream of images captured at a short focal length as needed once the object has been properly targeted.

There are many possible configurations for controlling the targeting, illumination and triggering of image capture functions. The illumination source 232 can be turned on when the contact switch 230 senses contact of an object, indicating that the user has placed the telephone on an object for close up image capture. The user can manually control the start and stop of image capture by pressing a button on the external housing of the camera, or through some other user interface, such as voice recognition. As another alternative, the application program that is examining the close up images can trigger an event when it has made a successful read, thereby concluding its use of the close up image stream provided by the driver.

Enabled Applications

As noted above, the functionality of the image capture system enables a wide variety of imaging applications in portable devices. These include:

Scanning of documents, including text documents. Software executing in the system can be used to stitch together images captured in close up mode as detailed in U.S. Pat. No. 6,513,717, which is hereby incorporated by reference. Once captured, there are a number of uses for the document including:

Saving the document for later reading in a viewer, such as Personal Computer or device with a larger display screen.

Converting images of text to alphanumeric text representations using OCR, enabling text editing and forwarding of text documents via email or file transfer protocols enabled in the cell phone.

Translate text from one language to another (example: looking at a menu in German . . . )

Spell-checking or Thesaurus functions executing in software on the device.

Using the captured and converted text as a basis for queries on the Internet or via other service providers accessible via the cell phones communication capabilities.

Using the cell phone as an intelligent magnifying glass to perform close up image capture and inspection, for use in:

Capturing and analyzing biometric images (finger prints or iris reading) and comparing with a local or remote database accessed via the cell phone's communication capabilities.

Validation of security features on value documents (micro-printing, etc.)

Other significant applications include reading of machine readable codes on objects, such as digital watermarks, bar codes, glyphs, high density printed codes, etc. Below, we describe digital watermark reading and applications in more detail. The close up mode can be used to read digital watermarks embedded at resolutions such as 150 dpi or higher.

Watermarking Logos and Graphical Icons

One application of digital watermark reading is to link objects to information or behavior on computer networks, as described in WO 00/70585, which is hereby incorporated by reference. This technology can be enabled in cell phones equipped with the image capture system described above.

In addition to the embedding digital watermarks in various forms of physical objects described in the patents referenced in this document, we have found that we can advantageously digitally watermark graphical icons (e.g., company logos or symbols). The digitally watermarked logos can be printed, e.g., in a magazine article or advertisement. The digital watermark may include a payload or identifier that can be used to link to a network resources such as a web site. For example, an embedded graphical logo is presented to an optical sensor. The optical sensor captures imagery corresponding to the embedded logo. A digital watermark decoder (e.g., software executing on a processor) analyzes the imagery to obtain the payload or identifier. The payload may include a URL or IP address which is used by a computer's internet browser to access a web site at the URL or IP address. Or the payload may be passed to a network router, which uses the payload to find a corresponding URL or IP address. Once found, the URL or IP address is passed back to the user's computer. (Other illustrative systems and environments are described below.).

Embedding graphical icons or logos provides additional value to a corporate symbol or trademark. Companies that put significant investments behind their logos (e.g., Nike's “Swoosh” or Intel's “Intel Inside,” etc.) can extend the capability of their logos by giving a logo additional functionality. Such functionality is preferably provided by marking the logo with steganographic and machine-readable indicia (e.g., a covert digital watermark). The indicia is preferably subtle to an observer, e.g., the steganography does not detract from the logo. The indicia preferably includes an identifier (e.g., a digital value). This identifier can be used as a pointer into a content lookup field, hence content can be retrieved upon reading the steganographic indicia. In other implementations the indicia includes encoded content.

Data retrieved can be stored for later review (e.g., book marking), or can be reviewed currently by displaying the content via different display formats (e.g., PDAs, TVs, computer monitors, etc.). Audio files can be played on home stereos, personal audio players, audio enhanced PDAs, cell phones, converged mobile devices, etc.

We have found that relatively small, watermarked icons or logos are efficient since they do not require an entire host image (e.g., a printed advertisement) to be watermarked. Embedding a relatively small logo or icon instead of redundantly embedding the entire host image can preserve image quality. Since there is no watermarking of the host image, we can avoid image degradation issues due to watermark noise. An encoded icon can also allow image capture of a targeted area by a handheld scanner (e.g., a cell phone).

In one implementation, we provide multiple encoded logos or icons on a single image (e.g., like on an advertisement). Each logo includes a unique identifier or unique encoded content. The identifiers are used to access different content. In some implementation the icons are representative of the data to be retrieved. For example, a “speaker and display screen” graphical icon may include an identifier embedded therein that can be used to link to multimedia content. Some logos include a specific meaning for data retrieval, e.g.:

a. logo x can link to location based service information;

b. logo y can link to multimedia information; and/or

c. logo z can link to text information (e.g., tour dates, availability dates, more product information, legal issues etc).

We can provide an extremely robust watermark (e.g., a watermark including a strong signal) with may of our embedded logos. For example, we can surround a corporate logo with a textured pattern, this pattern can be designed to conceal or hide a strong digital watermark signal. In many implementations our digital watermark will include an orientation component. The orientation component is helpful in resolving image distortion such as scale, rotation and translation, see, e.g., our U.S. Pat. No. 6,614,914 and application Ser. No. 10/202,367—published as US 2003-0039377 A1—which are each herein incorporated by reference. In other implementations a digital watermark message or payload works in conjunction with a somewhat visible fiducial pattern or alignment mark. These fiducials or alignments marks can be hidden or at least somewhat concealed in a textured pattern.

We envision that our steganographically embedded graphical logos will be particularly useful in broadband wireless environments. Our inventive techniques will provide an ability to easily link to compelling databases and network resources.

Our techniques will also allow for pointcast advertising (e.g., sending a targeted advertisement to a single user) for individual consumers instead of broadcast advertising (e.g., sending the same advertisement to many, such as with a TV ad). Consider a magazine advertisement including our steganographically marked logo or icon. A potential customer is interested in the ad, so they “read” (e.g., machine-read) a digitally watermarked icon. Reading the ad triggers a pointcast event (e.g., compelling content is sent to the potential costumer). Fortune 500 companies will save money as they can reduce their broadcast money by leveraging the internet and steganographic-based linking with low cost broadband technologies and consumer devices.

There are a number of possible configurations for the systems described in this document. Some example configurations are described in the following U.S. patent applications and patents: Ser. Nos. 09/476,686, 09/938,870 (published as US 2002-0099943), U.S. Pat. Nos. 5,841,978, 6,122,403, 6,411,725, 6,505,160, 6,522,769 and 6,614,914, which are each herein incorporated by reference. (Digimarc Corp., headquartered in Tualatin, Oreg., provides suitable digital watermarking software, e.g., under the trade name MEDIABRIDGE.).

In an exemplary system, the system components include a reader device at the user location, a database, a media content source, and a rendering device. The reader extracts a digital watermark from a watermark-enabled object (e.g., a logo). The reader forwards data from the watermark to the database, possibly through one or more intermediate hops across devices in a communication channel, such as first to a PC, home server, base station, and then to intermediate devices like routers, gateways, bridges, computers, switches, satellites and then on to the database, which typically resides in one or more servers.

The database system itself may include a front-end router computer for load balancing and passing the data to another server for a look up operation to determine the function and data associated with the watermark message extracted from the object. This look up operation may also be governed by a rule set that takes into account the user's preferences, user's device configuration, the user's content subscriptions, the user's access rights and licenses to certain types of content, the user's decryption keys for Digital Rights Management Delivery, the user's device environment (e.g., handheld vs. desktop), the user's location (e.g., geographic location or location of device within home) etc. Location based rules enable the system to provide content and promotions that are geographically relevant to the user, such as advertisements for products or services offered in the area.

After looking up the associated function to be initiated or data to be returned to the user, the database initiates a process to cause the function to be executed and/or data to be returned to the user location. There are several possible configurations for this process. One is to return control information (such as a media source IP address, content key, content ID, rendering instructions, etc.) to the user's reader or rendering device, which in turn, fetches data to be rendered on the rendering device from the media content source. Another is to forward control information to the media source directly, instructing it to forward data to be rendered to the rendering device at the user location. Variations and combinations may be employed to cause data to be returned to the user in response to the watermark data.

The media content source may be a server for web page delivery, streaming media delivery or file transfer to the rendering device. Alternatively, it may be a broadcast system, such as a cable or satellite broadcast system. Alternatively, it may be a wireless network delivery system.

The rendering device may be part of the reader or may be a separate device. Examples of the reader include a camera enabled cell phone, a PDA (wireless or tethered), a remote control unit for a home entertainment system with integrated camera, a home internet appliance with integrated or tethered camera, a personal computer with camera, a set top box with camera, etc. The rendering device may be a television, PDA, phone or computer with display and audio output equipment, or a variety of other devices with like output devices for presentation of the rendered audio or visual content returned from the media content source.

The system is particularly suited for delivery of content into a home entertainment network. In this network, a variety of computing devices are interconnected into a network, including, for example, one or more personal computers, televisions, set top boxes, home media terminals, home media content server, router, and gateway to the Internet. The reader may be a handheld device such as a remote control or PDA that communicates with other devices in the home network and the Internet through a wireless connection such as a wireless communication controller designed according to the 802.11 standards (IEEE 802.11a, b, g, etc.). This enables the reader to communicate wirelessly with the home Internet connection and then on to the database and the media content source over the Internet.

The reader may also be implemented as part of a wireless communicator such as a cell phone or PDA. For example, the reader may be implemented as part of a device that adheres to the 2.5G or 3G standards for wireless communication networks. This enables the reader to communicate wirelessly with the database and/or the media content source. All of the devices in the system may communicate via such a wireless network, including for watermark data transfer, control data transfer, and media content return to the rendering device. Alternatively, parts of the system may be implemented using conventional wire or broadcast networks. For example, the media content source can be instructed to send content to the user location over the Internet or through a cable television or satellite broadcast.

While the system is specifically described in terms of linking from printed media, similar systems may be implemented for linking from embedded signals in electronic signals, including video, audio and images in analog or digital format.

In the particular case of linking from watermark enabled logos, we have achieved satisfactory results using an embedding method described in assignee's U.S. Pat. No. 6,614,914 to embed a watermark signal conveying a watermark message of at least 60 bits at 150 dots per inch (DPI). The reliability of reading increases with the size of the image area over which we embed the digital watermark. We have found that embedding over an area of about 1.5 by 1.5 inches gives satisfactory detection rates. Further, we have found that we can achieve acceptable detection rates of the complete payload over an area of 0.625 by 0.625 inches. In these implementations, we use a watermark signal with an orientation component for geometric synchronization and a payload of 60 bits before error correction and repetition coding. The watermarked area is located around a logo, which provides a target area for the user to capture an image centered at the logo. In practice, the user places the image capture device, such as digital camera enabled cell phone, over the logo and presses a capture button to capture one or more image frames of the area around the logo.

In some cases, the spatial density of the watermark requires that the digital camera read the watermarked print media from a focal distance that is different than the focal distance used for typical applications of the camera, such as taking snapshots of people or sites of interest, video phone, etc. This can be addressed by designing the optical system so that it has different optical modes: 1. one for scanning print objects at close range of a few inches or less; and 2. a second for taking photos or capturing video at a farther range of distances, e.g., as discussed above with reference to FIGS. 16-19. The optical system may be adjusted mechanically or electronically. For example, it can be designed to pivot between two or more lens configurations, each adapted for taking-pictures at a desired range of distances. In the case of cell phone cameras or other handheld devices, the mechanical pivoting of the lens system can be integrated with the mechanical structure that pivots when the device housing is opened or closed, as is the case with cell phones that are unfolded to reveal a keypad for dialing etc. and then folded closed for stowing in a pocket.

The systems described and incorporated into this document enable a wide array of applications in addition to those already enumerated. The system enables the integration of e-commerce transactions and biometric data security checks. For example, in one application of our system, a cell phone or connected Personal Digital Assistant (PDA) reads a digital watermark around a logo in print media, identifies a product associated with the print media (e.g., the product or service depicted in a print advertisement or article), and presents a user interface giving the user the option to purchase the product or service immediately from the hand held by selecting the option. In this system, the relevant user information is stored in the handheld already in a secure memory location, such as the user's bank account numbers, credit card numbers, social security number, shipping address, etc. Without a security check, any one could order off your cell phone. To prevent fraud (e.g., unauthorized user using another's device to order products or services), the device is also equipped with a biometric data capture and checking system, such as a fingerprint, voice recognition, iris or retinal scan, facial recognition, hand written signature, etc. Such biometric data can be entered via the camera, microphone or electronic stylus on the handheld device. At the time of the transaction, the device queries the user to enter the biometric data. It then compares that biometric data with the user's biometric data stored in secure memory on the device or sends it over a secure communication protocol to a biometric database for authentication by comparison.

Since portable devices are typically small in size, providing a powerful user interface can be a challenge. While the digital watermark provides a convenient interface to get related content and functionality, the range of options that can be returned for each linked watermark creates a need for additional user interface controls to enable the user to select among the options. One potential system enhancement is to enable voice activated direction of the linking activity associated with a digitally watermarked object.

In some applications, the print media will have multiple watermarked locations on a page, each with different associated behaviors and/or functions presented to the user. For example, one digitally watermarked logo location links to options for location based services, another links to options for expanded multimedia content delivery (e.g., streaming audio or video), another links to more text information, etc. In some applications, the print object has limitations regarding the available area for marking and only one digitally watermarked location fits on the object due to size, aesthetic considerations.

In either case, a voice-activated feature on the phone or PDA directs the linking content by enabling the user to select options through voice recognition of the user's oral commands captured via a microphone. For example, if the user is in a store and sees a tag that is digitally watermarked as signified by the logo, the user can select from among multiple different payoff options returned by the system via voice activation.

The system enables a compelling set of applications where the digital watermark initiates the streaming of audio and or audio-visual content. One challenge in these applications is providing high quality audio or video in a convenient way to the user of a portable device. One solution is to couple the portable reader device with a wireless headset (e.g., one designed according to 802.11 standards) via a wireless connection. This enables the user to enjoy streaming audio content linked via the digital watermark with the freedom of a wireless headset. The potential applications are numerous. Some examples include a cooking magazine that has a watermark linked to a streaming audio of a 40 minute ‘walk through’ of a recipe. When coupled with voice activated controls for pausing, fast forwarding, and rewinding, the user is enabled with a powerful and convenient interface for directing the streaming of the content linked to the printed media. The wireless headset (e.g., bluetooth, WIFI, 802.11) allows unrestricted motion. In the case where the reader is a PDA, the PDA can be placed back in its local cradle or docking station, where it charges and streams audio from a network connection to the headset. This wireless streaming can also be extended to audio-visual content, where the video is transferred to a portable or fixed display device and the audio is transferred to the portable headset or fixed home audio system. Other applications of streaming content including audio and/or video include self help, meditation, religious, arts/crafts, self tutoring, sports instruction (such as a walk through guide to a golf swing), education, walk through legal forms, etc.

In addition to the combinations discussed above and in the claims, some example combinations include:

A1. A wireless telephone including:

a first portion;

a second portion;

a connector coupling the first portion and the second portion;

a camera including a lens and a CMOS sensor array to capture images, where at least the camera lens is provided on the first portion; and

a first display position provided on the second portion, wherein the first display displays images captured by the camera so as to allow alignment of the camera lens with an object at a close focal distance, wherein the object or a target area on the object would otherwise be obscured by at least one of the wireless telephone and the first portion.

A2. The telephone of A1, further including a button to trigger image capture.

A3. The telephone of A1, further comprising:

a steganographic indicia decoder that analyzes images captured by the camera to locate and decode steganographic indicia in the images.

A4. The telephone of A3, wherein the object comprises a graphic or logo including steganographic indicia.

A5. The telephone of A4, wherein the indicia comprises a digital watermark.

A6. The telephone of A4, wherein the display provides markings to assist with alignment.

A7. The telephone of A6, wherein the markings comprise cross-hairs.

A8. The telephone of A1, further comprising image processing circuitry to allow enhancement of images captured by the camera.

A9. The telephone of A8, wherein the enhancement comprises digital magnification or zooming.

A10. The telephone of A8, wherein the image processing circuitry comprise at least one of: i) a processor executing software instructions stored in cooperating memory; and ii) dedicated image processing circuitry.

A11. The telephone of A8, wherein the object comprises a human finger, and an image captured by the camera includes a fingerprint.

A12. The telephone of A8, wherein the object comprises a human eye, and an image captured by the camera includes a retina or iris image.

A13. The telephone of A1, wherein the connector includes a hinge.

A14. The telephone of A13, wherein the hinge comprises a pivoting hinge.

B1. A camera comprising:

an optical system including a multi-focal length lens structure, wherein the multi-focal length lens structure provides at least a first optical path and a second optical path;

an image sensor array partitioned into at least a first area and a second area, the first area to receive light associated with the first optical path and the second area to receive light associated with the second optical path;

selection circuitry to allow selection of image data corresponding to the first area and the second area;

a communications bus to provide image data from the first area and the second area.

B2. The camera of B1, wherein the image sensor array comprises a CMOS sensor.

B3. The camera of any one of B1 and B2, wherein partitioning of the image sensor comprises virtual partitioning.

B4. The camera of any one of B1-B3, further comprising memory and electronic processing circuitry.

C1. A home or office network comprising:

a wireless router; and

a handheld computing device, the handheld computing device comprising a camera and a wireless transceiver, the handheld computing device communicating with at least the wireless router via its transceiver, said handheld computing device comprising a digital watermark decoder, the handheld computing device capturing an image of a logo or icon, wherein the logo or icon includes a digital watermark embedded therein, the digitally watermarked logo or icon providing a human visual target reference area to assist a user of the handheld computing device when aligning the camera for image capture of the logo or icon, wherein the digital watermark decoder is operable to decode a digital watermark from image data.

C2. The network of C1, wherein the handheld computing device comprises a microphone or other interface to receive a voice command from the user.

C3. The network of C2, wherein the handheld computing device comprises memory including voice recognition instructions stored therein, wherein the voice recognition instructions are executed to analyze a voice command from the user, the voice command being utilized in connection with a decoded digital watermark to control operation of the handheld computing device.

C4. The network of C3, wherein the operation comprises selecting which of a plurality of decoded digital watermarks the user wishes to receive additional information on.

C5. The network of C3, wherein the operation comprises selection of one of a plurality of payoffs associated with the digital watermark and received via the wireless router.

C6. The network of any one of C1-C5, wherein the handheld computing device comprises at least one of a laptop, PDA and a wireless cellphone.

D1. A method of operating a cellphone or personal digital assistant, wherein the cell phone or personal digital assistant includes a camera, the method comprising:

optically capturing an image of at least a portion of an object with the camera, wherein the object includes steganographic indicia thereon, and wherein a captured image of at least a portion of the object includes a representation of the steganographic indicia;

analyzing the captured image to obtain the steganographic indicia;

prior to executing an action associated with the steganographic indicia,

obtaining a biometric associated with a user of the camera or personal digital assistant,

comparing the obtained biometric with an expected biometric;

executing the action only when the obtained biometric corresponds with the expected biometric in a predetermined manner.

D2. The method of D1, wherein the biometric includes a fingerprint, and the fingerprint is obtained by the camera.

D3. The method of D1, wherein the biometric is a retina or iris scan, and the retina or iris scan is obtained by the camera.

D4. The method of D1, wherein the cell phone or personal digital assistant includes a microphone, and the biometric is a voice print, wherein a voice sample is obtained by the microphone.

D5. The method of D1, wherein the cell phone or personal digital assistant includes a touch-sensitive display screen, and the biometric comprises a hand writing sample, the hand writing sample being obtained through the touch-sensitive screen.

D6. The method of D1, wherein the biometric comprises a facial recognition metric, and an image of the user's face is captured by the camera.

E1. A digital watermarking method comprising:

obtaining a digital representation of a logo;

embedding a digital watermark in the digital representation of the logo, the digital watermark being isolated in or closely around the logo and being redundantly embedded therein, wherein the digital watermark includes an orientation component to help resolve subsequent distortion of the logo and a message component; and

providing the embedded digital representation of the logo for printing.

E2. The method of E1, further comprising printing an embedded digital representation of the logo on an object.

E3. A method of detecting the logo printed according to E2 comprising:

using the logo as a target reference, optically capturing data corresponding to at least a portion of the logo with a handheld device;

wirelessly communicating data associated with the optically captured data from the handheld device.

E4. The method of E3, further comprising:

wirelessly receiving in the handheld device a payoff associated with the digital watermark from a server; and

presenting the payoff via the handheld device.

E5. The method of E4, wherein the data associated with the optically captured data comprises image data, and wherein the digital watermark is decoded from the image data in a device that is remotely located from the handheld device.

E6. The method of E4, further comprising:

prior to wirelessly communicating the data associated with the optically captured data, decoding the digital watermark to obtain the message component, wherein the data associated with the optically captured data comprises the message component.

E7. The method of any one of E1-E6, wherein the handheld device comprises at least one of a cellphone and PDA.

Concluding Remarks

To provide a comprehensive disclosure without unduly lengthening this specification, each of the above-identified U.S. patent documents is herein incorporated by reference.

Having described and illustrated the principles of the invention with reference to illustrative embodiments, it should be recognized that the invention is not so limited. The present invention finds application beyond such illustrative embodiments.

For example, the technology and solutions disclosed herein have made use of elements and techniques known from the cited documents. Other elements and techniques can similarly be combined to yield further implementations within the scope of the present invention. Thus, for example, single-bit watermarking can be substituted for multi-bit watermarking, local scaling of watermark energy can be provided to enhance watermark signal-to-noise ratio without increasing human perceptibility, various filtering operations can be employed to serve the functions explained in the prior art, watermarks can include subliminal graticules to aid in image re-registration, encoding may proceed at the granularity of a single pixel (or DCT coefficient), or may similarly treat adjoining groups of pixels (or DCT coefficients), the encoding can be optimized to withstand expected forms of content corruption. Etc., etc., etc. Thus, the exemplary embodiments are only selected samples of the solutions available by combining the teachings referenced above. The other solutions necessarily are not exhaustively described herein, but are fairly within the understanding of an artisan given the foregoing disclosure and familiarity with the cited art.

The section headings are provided for the reader's convenience and should not be construed as limiting the scope of the present invention. Moreover, we expressly contemplate additional combinations that draw from multiple different sections of this application. Thus, features and elements found under one section heading may be readily combined with features and elements found under another section heading.

The implementation of some of the functionality described above (including watermark or steganographic encoding and decoding) can be implemented by suitable software, stored in memory for execution on an associated processor or processing circuitry. In other implementations, the functionality can be achieved by dedicated hardware, electronic processing circuitry or by a combination of hardware and software. Reprogrammable logic, including FPGAs, can advantageously be employed in certain implementations.

In view of the wide variety of embodiments to which the principles and features discussed above can be applied, it should be apparent that the detailed embodiments are illustrative only and should not be taken as limiting the scope of the invention.

What is claimed is:

1. A method of authenticating an object, wherein the object includes first machine-readable indicia thereon, the first machine-readable indicia including a first component, said method comprising:
providing a separate layer over the object, wherein the separate layer includes second machine-readable indicia thereon, the second machine-readable indicia comprising a second component;
optically capturing an image of at least a portion of the separate layer when provided over the object, wherein at least a portion of the object is perceptible through the separate layer in the image;
machine-reading the second component from the captured image; and
resolving the first component from the captured image with at least reference to the second component.

2. The method of claim 1, wherein the first component comprises an encrypted message, and the second component comprises a key to decrypt the encrypted message, wherein said resolving comprises machine-reading the first machine-readable indicia to recover the encrypted message and decrypting the encrypted message with the key.

3. The method of claim 1, wherein the first component comprises a digital watermark message and the second component comprises a digital watermark orientation component, wherein said resolving comprises aligning the image according to the orientation component and then machine-reading the digital watermark message.

4. The method of claim 1, wherein the first component comprises at least a message, and the second component identifies a protocol for reading the message, wherein said resolving comprises using the protocol when machine-reading the message.

5. The method of claim 1, wherein the first component comprises a first set of layers and a second set of layers, with the second component resolving only the first set of layers.

6. The method of claim 5, wherein the set second of layers corresponds to a different separate layer.

7. The method of claim 5, wherein the object comprises an identification document and the first set of layers comprises message fields corresponding to information contained elsewhere on the identification document.

8. The method of claim 1, wherein at least one of the first machine-readable indicia and the second machine-readable indicia comprises digital watermarking.

9. The method of claim 1, wherein the first machine-readable indicia comprises at least one of a barcode, data matrix and glyph, and the second machine-readable indicia comprises digital watermarking.

10. A method of marking objects comprising:
receiving plural-bit information; and
providing a steganographic signal including the plural-bit information on a surface of the object with metallic ink,
wherein the steganographic signal has a first polarity associated therewith, and wherein an illicit copy of the object results in a second—different—polarity associated with the steganographic signal as represented in the copy.

11. The method of claim 10, wherein the steganographic signal is conveyed in terms of differing contrast levels, and the first polarity is a measure of relative contrast between the steganographic signal and at least one of the surface of the object and indicia on the surface of the object.

12. The method of claim 11, wherein the second—different—polarity results from light reflection associated with the metallic ink.

13. The method of claim 10, wherein the steganographic signal comprises digital watermarking.

14. A method of marking an object comprising:
providing a steganographic signal on a top surface of a receiving layer, wherein the receiving layer comprises a bottom surface that is adjacently arranged with a substrate; and
covering the steganographic signal with a transparent material so that the steganographic signal remains machine-readable through the transparent material,
wherein the covered receiving layer remains adapted for separation from the substrate, and
wherein once separated, the covered receiving layer may be affixed on an object surface.

15. The method of claim 14, wherein the transparent material comprises at least one of an epoxy and polyurethane

16. The method of claim 14, wherein transparent material comprises a dome.

17. A method to access how-to information over a wireless network comprising:
optically scanning an object include steganographic indicia thereon, wherein the indicia comprises an identifier;
wirelessly communicating the identifier to a server;
receiving how-to information associated with the object from the server; and
providing the how-to information for user observation through a device cooperating with the wireless communication.

18. The method of claim 17, wherein the object comprises at least one of a cookbook, golf club, golf ball and golf paraphernalia, and the how-to information comprises multimedia instructions corresponding to at least one of cooking and golfing instructions.

19. The method of claim 17, wherein the device comprises a wireless headset.

20. A method to access information over a wireless network comprising:
receiving optical scan data representing at least a portion of an object including stegapographic indicia thereon, wherein the indicia comprises an identifier;
wirelessly communicating the identifier to a server;
receiving a plurality of information choices from the server, wherein the plurality of information choices are each associated with the identifier, but each vary from one another in some manner;
receiving a voice-activated command selecting one of the plurality of information choices for presentation; and
presenting an information choice corresponding to the selected one of the plurality of information choices.

21. The method of claim 20, wherein the steganographic indicia comprises digital watermarking.

22. An attachment for use with a camera, the camera to capture an image of at least a portion of an object, wherein the object comprises a surface including machine-readable indicia thereon, wherein the camera includes a lens, said attachment comprising:
an enclosed housing establishing a minimum possible distance between the lens and the object;
a relatively light colored surface provided within or at a terminating ending of the housing, the relatively light colored surface being provided to face the object when the housing is placed over at least a portion of the object; and
an opening provided in the relatively light colored surface, wherein the opening is configured so as to at least receive the camera lens therein or to allow image capture by the lens through the opening.

23. The attachment of claim 22, further comprising an illumination source.

24. The attachment of claim 23, wherein the illumination source is provided so as to be positioned between the relatively light colored surface and the object, wherein the light source is directed toward the relatively light colored surface.

25. The attachment of claim 22, further comprising a relatively light colored sleeve provided in the housing so as to inwardly face, an edge of the sleeve being adjacently arranged with the relatively light colored surface.

26. The attachment of claim 22, wherein the housing is perpendicular with respect to the object when placed over at least a portion of the object.

27. The attachment of claim 22 wherein the housing is provided at an angle with respect to the object so as to shift a reflection of the lens in an image captured by the camera away from a middle of the captured image.

28. The attachment of claim 22 wherein the machine-readable indicia comprises digital watermarking.

29. A camera including a lens and the attachment of claim 22.

30. The attachment of claim 22, wherein the camera is a video camera.

31. The attachment of claim 22, wherein the surface comprises a shinny surface.

32. The attachment of claim 22, wherein the surface comprises a specular surface.

33. The attachment of claim 22, wherein the surface comprises a metallic finish.

34. A portable device comprising:
an image capture system with two or more modes of image capture, one mode for capturing images at a short focal length, and another mode for capturing images at a longer focal length; and
a sub-windowing module for accessing image streams captured at the short and longer focal lengths.

35. The portable device of claim 34 wherein the portable device is cellular telephone.

36. The portable device of claim 35 wherein the telephone includes an illumination source for illuminating an object for image capture during image capture at the short focal length.

37. The portable device of claim 36 wherein the telephone includes a contact switch for triggering image capture when the telephone is placed on an object.

38. The portable device of claim 37 wherein the contact switch triggers digital watermark reading from images captured of the object.

39. A method to access information over a wireless network comprising:
receiving optical scan data representing an object including steganographic indicia thereon, wherein the indicia comprises at least one identifier;
communicating at least a portion of the optical scan data to a server for decoding of the steganographic indicia;
receiving a plurality of information choices from the server, wherein the plurality of information choices are each associated with the identifier, but each vary from one another in some manner;
receiving a user-activated command selecting one of the plurality of information choices for presentation; and
presenting an information choice corresponding to the selected one of the plurality of information choices.

40. The method of claim 39, wherein said communicating comprises wireless communication.

41. The method of claim 39, wherein the steganographic indicia comprises digital watermarking.

42. The method of claim 39, wherein the user-activated command comprises a voice command.

43. The method of claim 39, wherein said steps are carried out on a cellphone.

44. The method of claim 39, wherein said steps are carried out on a handheld personal digital assistant.

45. A digital watermarking method comprising:
receiving a host image, wherein the host image includes plural-bit data embedded therein, the plural-bit data including data corresponding to an authorized bearer of an identification document, the host image further comprising a digital watermark orientation component embedded therein;
providing the watermarked host image to a laser engraving apparatus; and
guiding laser engraving apparatus to laser engrave an identification document so as to represent the watermarked host image.

46. The method of claim 45, wherein the digital watermarking conveys two or more digital watermarks.

47. The method of claim 45, wherein said host image comprises a binary image.

48. The method of claim 45, wherein said host image comprises a grayscale image.
